(19) United States
(12) Patent Application Publication
(10) Pub. No.: US 2009/0240517 A1
(43) Pub. Date: Sep. 24, 2009

(54) Method and system for attribute-based evaluation of travel-related products and services

(76) Inventor: David E. Pelter, Seattle, WA (US)

Correspondence Address: OLYMPIC PATENT WORKS PLLC, P.O. BOX 4277, SEATTLE, WA, 98104, US

(21) Appl. No.: 12/291,508

(22) Filed: Nov. 10, 2008

Related U.S. Application Data
(60) Provisional application No. 60/987,009, filed on Nov. 9, 2007.

(51) Int. Cl. G06Q 30/00

(52) U.S. Cl. 705/1

(57) ABSTRACT

Embodiments of the present invention are directed to providing automated evaluation of travel-related products and services to consumers. The evaluations may be carried out by a travel-related-products-and-services provider, by a separate products-and-services evaluator on behalf of the vendor, or by a client-side component of an evaluation system. Travel-related products and services are evaluated, according to certain embodiments of the present invention, by computing values for a number of attributes associated with travel-related products and services, and by then computing one or more scores based on the computed values of the attributes. In certain embodiments of the present invention, one or more scores for each travel-related product and/or service are displayed to a user to facilitate the user's selection of a product and/or service.

### CROSS-REFERENCE TO RELATED APPLICATION

This application claims the benefit of Provision Application No. 60/987,009, filed Nov. 9, 2007.

### TECHNICAL FIELD

The present invention is related to automated evaluation of travel-related products and services and, in particular, to a method and system that evaluates one or more descriptions of travel-related products and/or services by evaluating a number of attributes associated with travel-related products and services and by then computing one or more scores from the attribute values.

### BACKGROUND OF THE INVENTION

During the past ten years, the emergence of widespread usage of the Internet for retailing products and services has greatly transformed consumer access to products and services. It is currently possible for consumers to easily and efficiently comparison shop for products and services on the Internet, to obtain detailed consumer reports about, and evaluations of, products and services from the Internet, and to purchase the products and services from Internet retailers. Many Internet retailers provide detailed consumer evaluations of the products and services offered by the Internet retailers, and certain Internet retailers provide links to alternative sources of products and services, should a consumer wish to purchase products and services from a retailer other than the retailer through which the consumer initially accesses product-and/or-service information.

While the amount of information available to consumers with regard to available products and services has increased enormously, and while the overall efficiency and convenience of Internet-based shopping represents a huge improvement over telephone, catalog-based, and travel-to-retail-establishment-based shopping, the ease and efficiency of Internet-based electronic shopping is, nonetheless, evaluated from the standpoint of overall improvements in communications made possible by technological advances. There is still room for improvement in the efficiency and ease of use by which consumers can evaluate alternative purchase options. In particular, evaluating and purchasing travel-related products and services may still pose numerous problems and inefficiencies to consumers. There are, for example, many different aspects to even simple travel products, including air travel to and from a specific destination. Although detailed information on any particular flight or itinerary is available on the Internet, a consumer may nonetheless need to spend significant time and effort in locating and assembling the information in order to evaluate particular travel products. Similar considerations apply to travel agents using the Internet to locate travel options for clients. Travel-product vendors, Internet-based travel-product-and-service providers, web-based retail-site developers, and, ultimately, consumers of products marketed and advertised through the Internet, continue to seek new and better methods and systems for Internet-based retailing of travel-related products and services.

### SUMMARY OF THE INVENTION

Embodiments of the present invention are directed to providing automated evaluation of travel-related products and services to consumers. The evaluations may be carried out by a travel-related-products-and-services provider, by a separate products-and-services evaluator on behalf of the vendor, or by a client-side component of an evaluation system. Travel-related products and services are evaluated, according to certain embodiments of the present invention, by computing values for a number of attributes associated with travel-related products and services, and by then computing one or more scores based on the computed values of the attributes. In certain embodiments of the present invention, one or more scores for each travel-related product and/or service are displayed to a user to facilitate the user's selection of a product and/or service.

### BRIEF DESCRIPTION OF THE DRAWINGS

FIG. 1A illustrates automated evaluation of travel-related products and services, according to embodiments of the present invention, in a generalized context.

FIG. 1B illustrates the requests-and-information provision provided by components of the travel-related products-and-services evaluation system according to one embodiment of the present invention.

FIG. 1C illustrates a second embodiment of the present invention.

FIG. 1D illustrates a third embodiment of the present invention.

FIG. 1E shows a fourth alternative embodiment of the present invention.

FIG. 1F illustrates a fifth embodiment of the present invention.

FIG. 2 illustrates evaluation of travel-related products and services according to various embodiments of the present invention.

FIGS. 3A-C provide control-flow diagrams for a general “score entries” routine used to evaluate and score each product and/or service in a list of products and/or services according to embodiments of the present invention.

FIG. 4 shows how an itinerary data record is created in the distribution and sale of airline tickets according to various embodiments of the present invention.

FIG. 5 demonstrates one example of the travel scoring matrix interaction with the itinerary data record in the evaluation of airline itineraries according to various embodiments of the present invention.

FIG. 6 illustrates an example interface of an example trip quality dashboard according to various embodiments of the present invention.

FIG. 7 illustrates a relational database structure for use with the TSMs and travel scoring processes according to on embodiment of the present invention.

FIGS. 8-11 illustrate user steps in evaluating travel options according to one embodiment of the present invention.

FIG. 12 illustrates licensing of the travel scoring matrix and travel scoring process to third parties for use in their applications according to on embodiment of the present invention.

FIG. 13 illustrates a private/white label of consumer-facing travel shopping web site by embedding a portion or entire TQSS into a third party application to provide travel functionality according to on embodiment of the present invention.

FIG. 14 is an example block diagram of use of a Travel Quality Scoring System to provide quality measurements of travel-related products.

FIG. 15 is an example block diagram of example components of a Travel Quality Scoring System.

FIG. 16 is an example block diagram of an example computing system that may be used to practice embodiments of a Travel Quality Scoring System.

### DETAILED DESCRIPTION OF THE INVENTION

Embodiments of the present invention are directed to automated evaluation of travel-related products and services to facilitate purchase of travel-related products and services by consumers. Embodiments of the present invention are described, below, in three subsections and two appendices. A first subsection provides an overview of a variety of embodiments of the present invention. A second subsection provides a more detailed discussion of several embodiments of the present invention. A third subsection provides additional details of hardware platforms used for, and architectures of, embodiments of the present invention. A first appendix includes a database schema for one embodiment of the present invention, and a second appendix includes detailed pseudocode for an implementation of that embodiment of the present invention.

### Overview

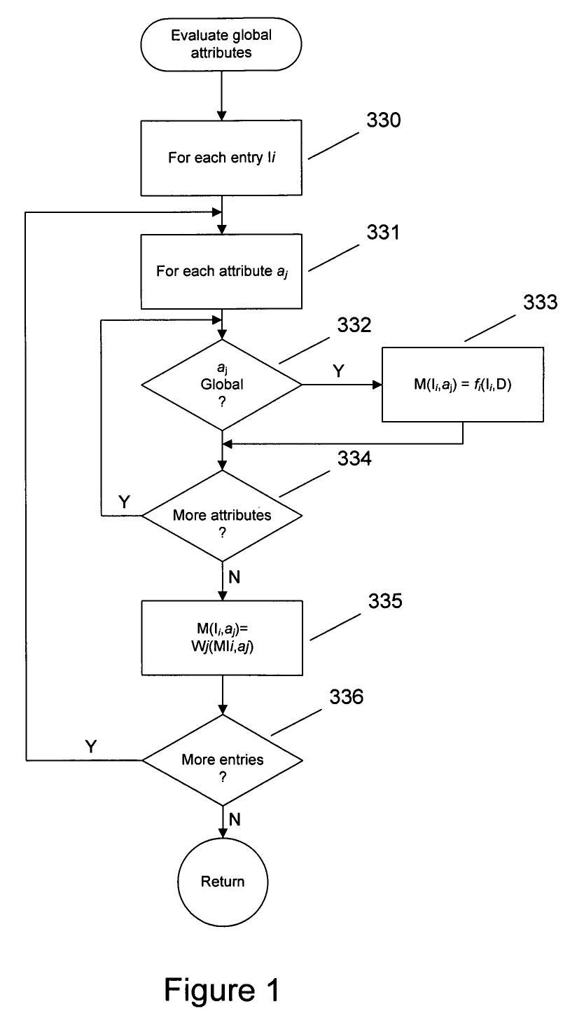

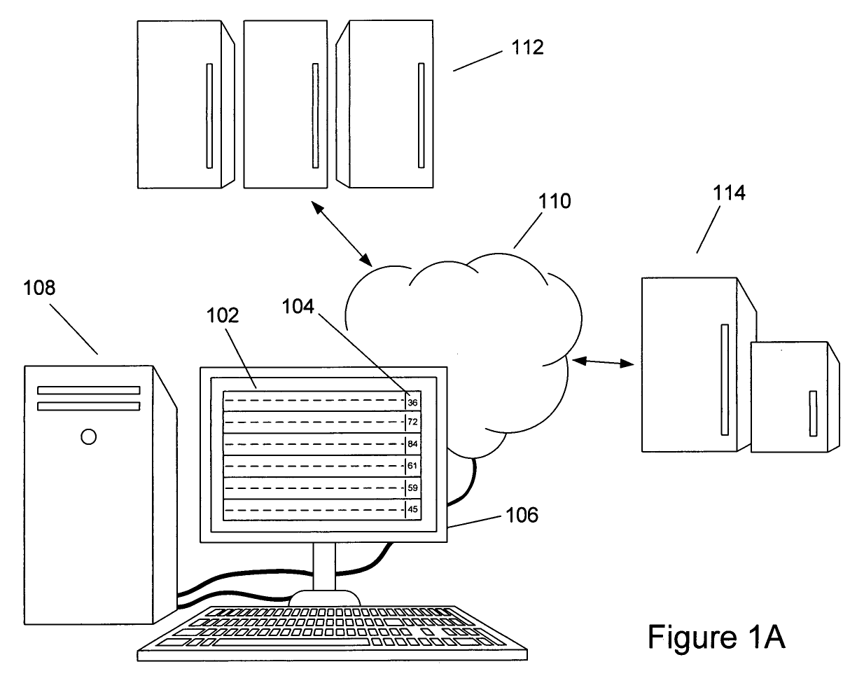

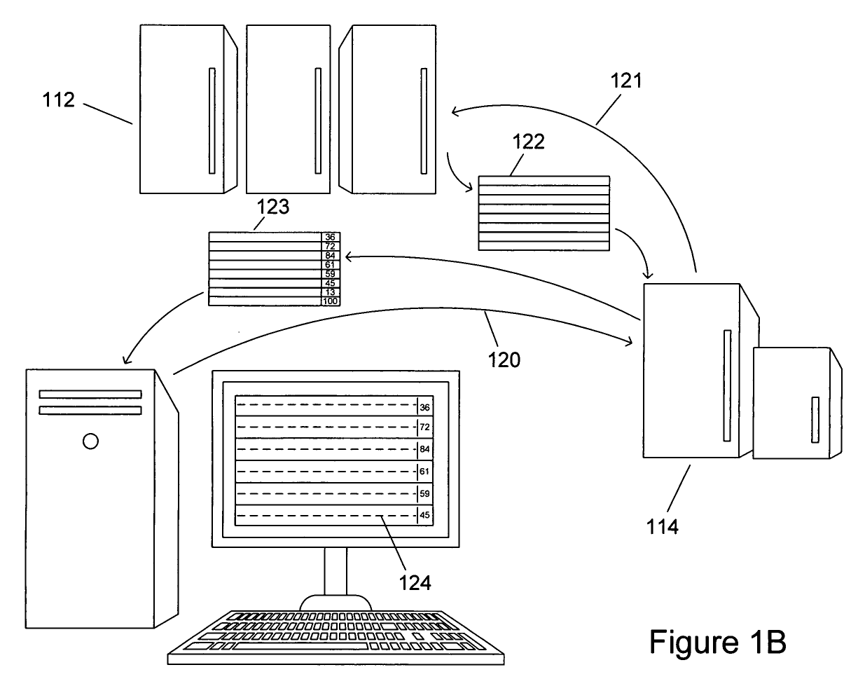

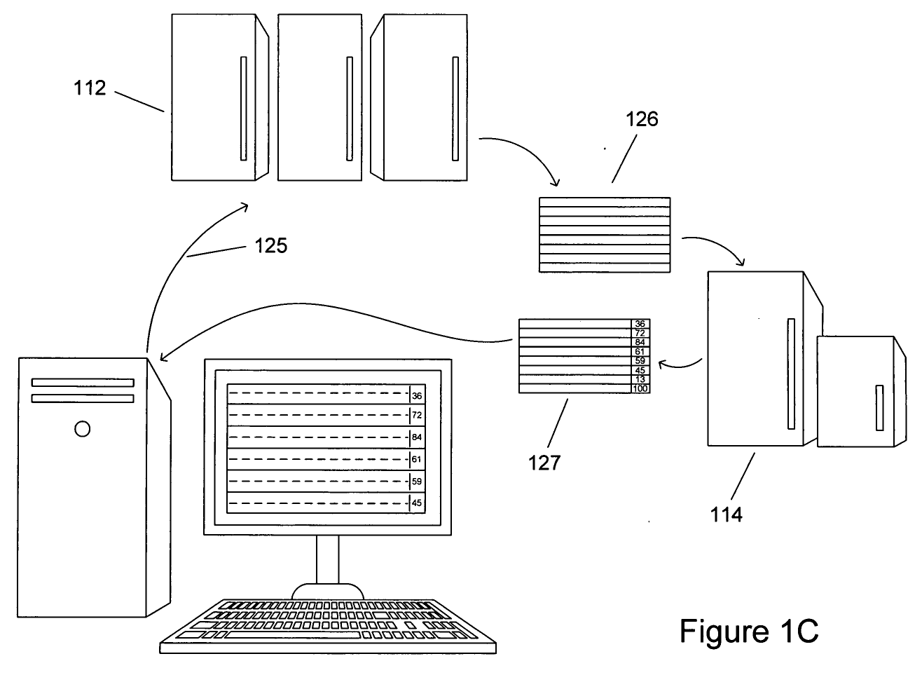

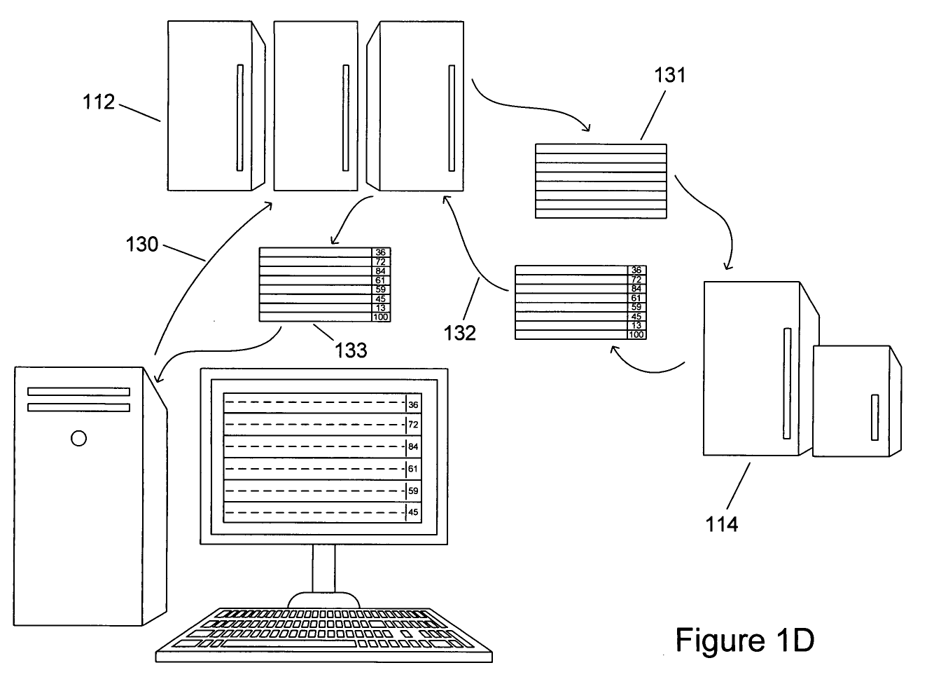

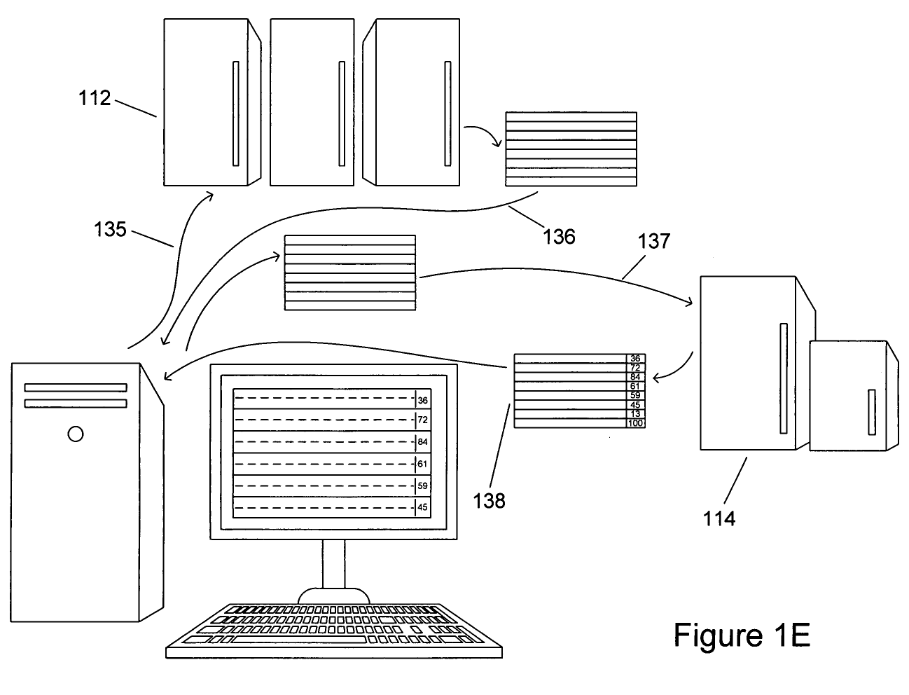

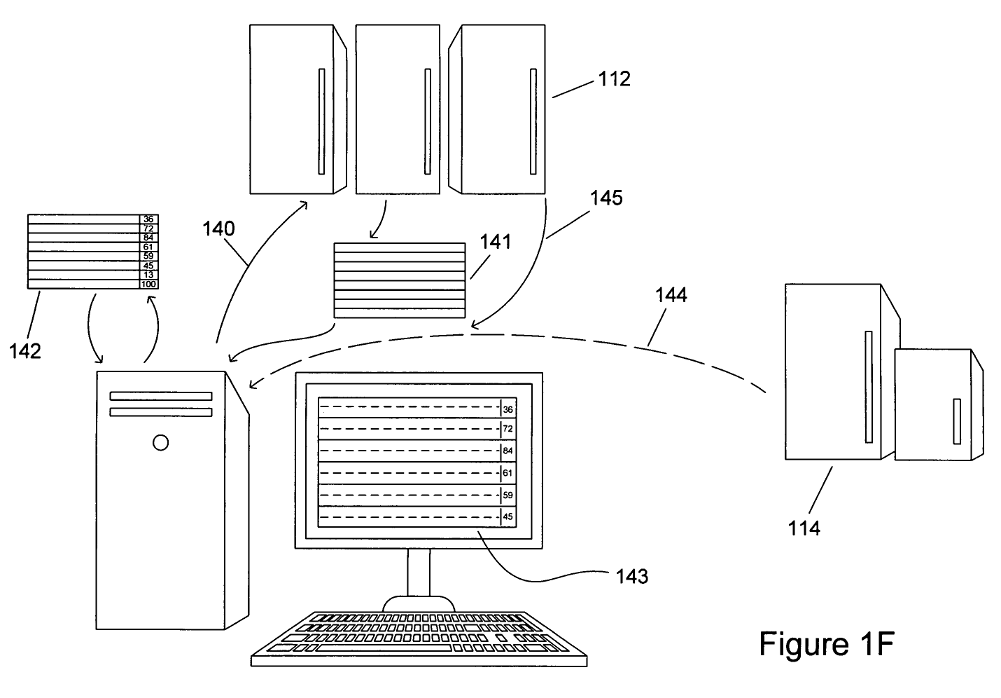

FIGS. 1A-F illustrate automated, attribute-based evaluation of travel-related products and services according to various embodiments of the present invention. FIG. 1A illustrates automated evaluation of travel-related products and services, according to embodiments of the present invention, in a generalized context. In FIG. 1A, a list of alternative products and/or services 102, along with evaluation scores, such as evaluation score 104, is displayed on a display monitor 106 of a consumer's personal computer (“PC”) 108. The list of travel products and/or services 102 and associated evaluation scores are obtained by the user from one or more remote service providers via the Internet 110, the one or more service providers including a travel-related products-and-services vendor 112 (“vendor”) and a travel-related products-and-services evaluation service 114 (“evaluation service”). In FIG. 1A, the travel-related products-and-services vendor 112 and travel-related products-and-services evaluation service 114 are each represented as a high-end computer cluster with associated data storage.

In general, a consumer requests information about travel-related products and/or services through a web browser or other client-side application program. The client-side application program, in turn, requests the information, on behalf of the consumer, from either the vendor 112 or the evaluation service 114. The requested information is returned to the client-side application, which assembles the information into a graphical display 102 annotated with evaluation results. In the case shown in FIG. 1A, numeric scores associated with each alternative travel-related product or service are displayed in the list of products and services 102. As one example, the consumer may have requested information about vacation packages to luxurious tropical islands, and, in response to the request, is presented with a graphical list of various alternative tropical-island holiday packages, each annotated with an evaluation score, such as evaluation score 104, representing a total desirability or quality of the travel package as determined by an automated travel-related products-and-services evaluation method and system, according to one embodiment of the present invention. As discussed in greater detail, below, the evaluation score may be a single, total score or, alternatively, may comprise numerical or text values for one or more attributes associated with the products and services. Furthermore, as discussed below, the attributes evaluated, and the weights associated with the attributes, may be, in certain embodiments of the present invention, selected by the user so that the automated evaluations are tailored to reflect the user's personal criteria for evaluating products and services.

FIG. 1B illustrates the requests sent, and information provided, by components of the travel-related products-and-services evaluation system according to one embodiment of the present invention. FIGS. 1C-F illustrate alternative embodiments of the present invention using the same illustration conventions. In the embodiment shown in FIG. 1B, the user requests information about a specific type of travel-related product or service 120 by directing a request to the evaluation service 114. The evaluation service, in turn, requests information about the travel-related product or service 121 from the vendor 112, which returns a list of travel-related product or service alternatives 122 to the evaluation service. The evaluation service then automatically evaluates each alternative, producing an evaluation score that the evaluation service uses to annotate the list of alternatives, returning the annotated list of alternative product or service options 123 to the client-side application on the user's PC. The client-side application then displays the annotated list of alternative product or service options 124 on the display monitor of the user's PC. Alternatively, the annotated list of alternative product or service options can be printed on a printer, stored in a computer-readable medium for subsequent access by the user, or transmitted for display, storage, or printing by another of the user's electronic devices.

FIG. 1C illustrates a second embodiment of the present invention. In FIG. 1C, the request for information is sent 125 by the client-side application on the user's PC to the vendor 112. The vendor prepares a list of alternative products and services 126 and transmits that list to the evaluation service 114. The vendor evaluates the alternatives, annotates the list with evaluation scores. and returns the annotated list 127 to the client-side application on the user's PC for communication to the user via display, printing, storage for subsequent access, or transmission to another of the user's devices.

FIG. 1D illustrates a third embodiment of the present invention. In the third embodiment, the request for product and/or service information is sent 130 by the client-side application on the user's PC to the vendor 112. The vendor prepares a list of alternative product and/or service options and transmits that list 131 to the evaluation service 114. The evaluation service evaluates the alternatives, assigns to each alternative one or more evaluation scores, and returns the evaluation scores back 132 to the vendor, which, in turn, forwards the annotated list of alternatives 133 to the client-side application on the user's PC. FIG. 1E shows a fourth alternative embodiment of the present invention. In this embodiment, the client-side application on a user's PC transmits a request for information about specific products and/or services 135 to the vendor 114, which prepares a list of alternative products and services and returns the list 136 back to the client-side application. The client-side application then forwards the list of alternatives 137 to the evaluation service 114. The evaluation service evaluates the alternatives and assigns evaluation scores to the alternatives, returning the assigned scores 138 back to the client-side application for communication to the user. FIG. 1F illustrates a fifth embodiment of the present invention. In this embodiment, the client-side application transmits the request for product-and/or-service information 140 to the vendor 112, receiving back from the vendor a list of alternative products and services according to the request 141. The client-side application then carries out an evaluation of the returned product-and/or-service list, assigning scores to each alternative 142. The client-side application then displays the list of alternatives annotated with the evaluation scores 143. The client-side evaluation program may access locally stored information that is periodically updated 144 by the evaluation service 114 or, alternatively, by the vendor 145.

To summarize FIGS. 1A-F, embodiments of the present invention provide automatic evaluation of travel-related products and/or services. The automated evaluation may be carried out by one or more evaluation programs that run on an evaluation-service computer system, that run on a vendor computer system, or that run on a user's PC. A client-side application running on the user's PC requests information about a specific travel-related product or service from either the vendor, in certain embodiments, or the evaluation service, in other embodiments of the present invention, and the requested information is then evaluated by the automated evaluation programs in order to annotate of the information about specific travel-related product or service with evaluation scored for return to the user. Results of automated evaluation may be one or more numeric, textural, or graphical scores that facilitate rapid comparison, by a user or consumer, in order to select the best alternative product or service from a list of alternatives.

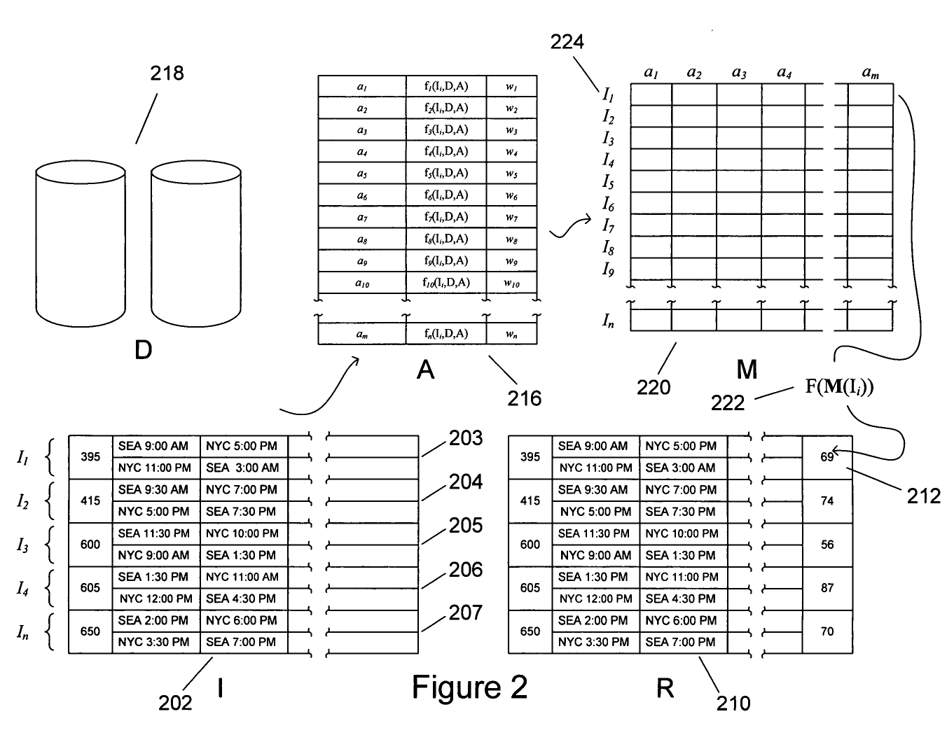

FIG. 2 illustrates evaluation of travel-related products and services according to various embodiments of the present invention. In FIG. 2, a list 202 of travel itineraries 203-207 is evaluated according to various attributes to produce, for each itinerary, a final numeric score. The scores are then used to annotate the list of itineraries to produce a result set of itineraries 210. Thus, for example, itinerary I₁ 203 is evaluated as having an evaluation score of “69” 212. In FIG. 2, the contents of the itineraries are shown as they would be displayed to a user in a graphical user interface. Of course, for computational purposes, this information may be stored in various different records or database tables.

Evaluation of the itineraries I₁, I₂, . . . , Iₙ in the initial list of itineraries I is essentially, in one embodiment of the present invention, a two-step process. In a first step, a function fⱼ(Iᵢ,D,A) associated with each attribute aⱼ along a list of attributes A is called to return a value for the attributed aⱼ for each entry i. In FIG. 2, the list of attributes A₁, A₂, . . . , Aₘ are shown as a table 216. Evaluation of each attribute Aⱼ for each individual itinerary Iᵢ may involve consideration of the information contained in the itinerary Iᵢ, information accumulated by an evaluation service and stored in a database D 218, and the values of other attributes associated particularly with itinerary Iᵢ or associated with any or all of the itineraries I₁, I₂, . . . , Iₙ. Each attribute in Table A 216 is also associated with a weight. Evaluation of each attribute for each itinerary produces a matrix M 220 of itinerary/attribute values. In a first pass, the attributes for which values can be determined solely from information contained in the corresponding itinerary and from the database are evaluated, and, in a second pass, all remaining attributes are evaluated. Finally, one or more final scores are computed for each itinerary based on the contents of matrix M, the computation represented in FIG. 2 by the function F(M(Iᵢ)) 222. In other words, in order to produce the total score “69” 212 for the first itinerary I₁, the function F is called with values for all of the attributes associated with itinerary I₁, stored in the first row 224 of the matrix M 220. In cases of incomplete information, default values for attributes may be used. Note that the weights associated with attributes are used to modify the attribute values returned by the functions f₁, f₂, . . . , fₙ in order to tailor evaluation for particular users or classes of users. Attribute values in the final completed scores are generally normalized with respect to the applied weights in order to produce a uniform range of scores or other metrics that represent results of the evaluation process.

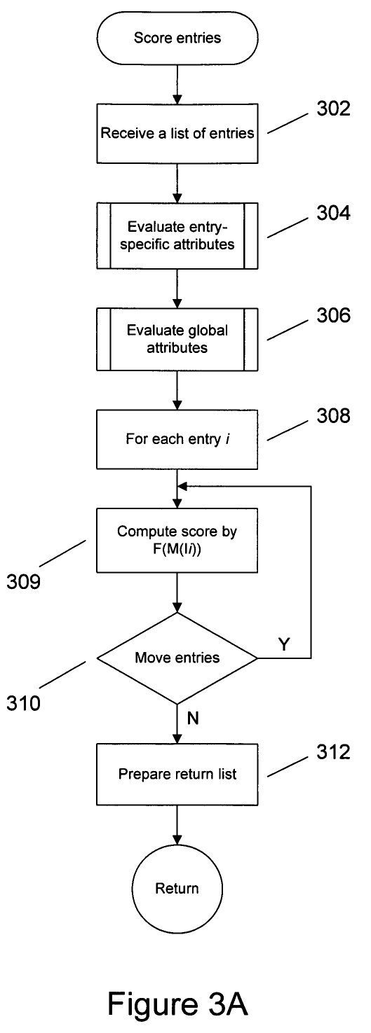

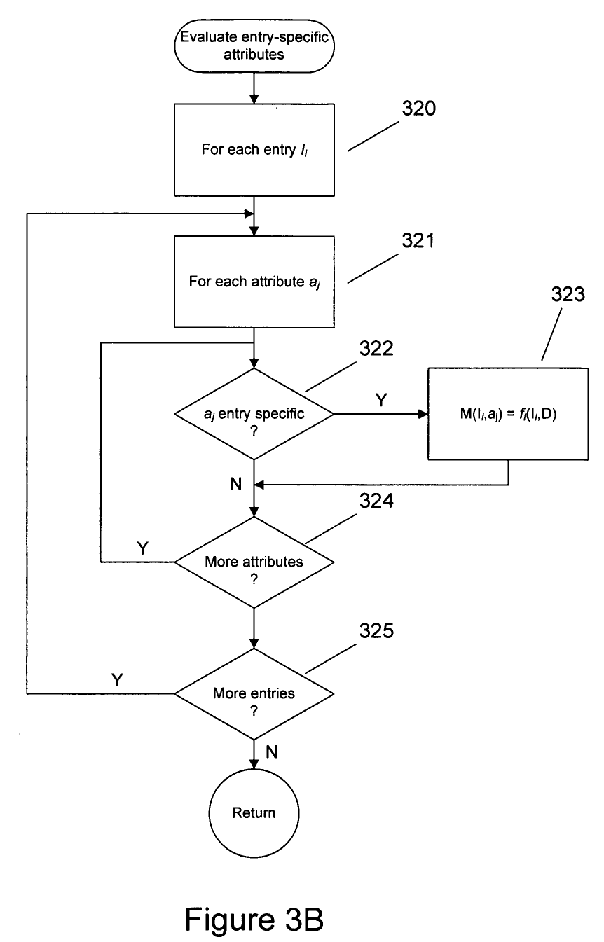

Evaluation of travel-related products and/or services, as discussed above, may be carried out in a vendor computer system, an evaluation-service computer system, or in a consumer's PC. In general, a list of products and/or services is obtained from an information source and then evaluated by one or more computer programs that assign one or more evaluation scores to each entry in the list. FIGS. 3A-C provide control-flow diagrams for a general “score entries” routine used to evaluate and score each product and/or service in a list of products and/or services according to embodiments of the present invention.

FIG. 3A provides a control-flow diagram for the routine “score entries.” In step 302, a list of entries is received. As discussed above, the entries are essentially records with data fields that describe a travel-related product or service, such as an air-travel itinerary, a vacation package, or some other travel-related product or service. In step 304, those attributes that can be evaluated from information contained in the entries or in a database are evaluated for each entry in the list of entries received in step 302. In step 306, any remaining attributes, the evaluation of which depend on values of other attributes, are evaluated. Then, in the for-loop comprising steps 308-310, each entry in the list of entries is assigned one or more evaluation scores by considering the attribute values for each entry determined in steps 304 and 306, above. Finally, in step 312, the scores are prepared for communication to a user. The scores may, in certain embodiments, be used to annotate the originally received list of entries, as shown in FIG. 2. Alternatively, the scores may be returned for subsequent combination with the list of entries, by a client-side application, or for use in preparing any of numerous different types of displays of the information to the user.

FIG. 3B is a control-flow diagram for the routine “evaluate entry-specific attributes” called in step 304 of FIG. 3A. This routine includes an outer for-loop, comprising steps 320-325, in which each entry in the list is considered, and an inner for-loop, comprising steps 321-324, in which each attribute in the list of attributes is considered. When the currently considered attribute can be evaluated considering only information contained in the currently considered entry and the database, the currently considered attribute is evaluated in step 323.

FIG. 3C is a control-flow diagram for the routine “evaluate global attributes” called in step 306 of FIG. 3A. This routine also consists of an outer for-loop, comprising steps 330-336, in which each entry is considered and an inner for-loop, comprising steps 331-335, in which each attribute is considered. If the currently considered attribute has not yet been evaluated, due to the fact that it depends on the values of other attributes, as determined in step 332, then the attribute is evaluated in step 333. Following evaluation of all the attributes for a particular entry, the weights associated with each attribute are multiplicatively applied to the attribute values to produce final attribute values for storage in the matrix M (220 in FIG. 2), in step 335.

The contents of the database (218 in FIG. 2), list entries (203-207 in FIG. 2), the number and types of attributes and the associated functions for computing attribute values (216 in FIG. 2), and the evaluation routine (220 in FIG. 2) may all very significantly depending on the particular client-side application, type of product and/or service being evaluated, the client-side application, and the evaluation service. Particular embodiments of the present invention are discussed, below, with detailed descriptions of the attributes, attribute-value-calculation routines, database contents, and entry contents.

### One Embodiment of the Present Invention

An example Travel Quality Scoring System (“TQSS”), called InsideTrip™, provides an evaluation mechanism for travel that ingests standard itinerary data from a global distribution system or other travel distribution system that emits travel and/or itinerary data, compares the ingested data to a set of quality metrics, and generates a composite trip quality score (“TQS”). The TQSS creates the trip quality score based upon attributes of the travel product in question, which are referred to as “trip attributes,” as they typically pertain to an instance of travel, such as a trip to a particular destination.

The quality evaluation involves examining the elements that compose the travel experience and scoring typically dozens of these elements using a matrix of trip attributes (“TSM”), along with one or more travel scoring functions (“TSPs”) that evaluate the relevant itinerary data against the matrix using one or more different methodologies. The matrix may also have rules, including business rules and attribute mappings, for determining respective values and/or weightings for each of the attributes. The itinerary data may be received in near real-time, periodically, or at specific times or intervals from one or more travel distribution systems or from other external or internal data sources. The default TQS can take into account a multitude of travel product aspects, for example, data that maps to 45 or more individual trip attributes, to generate a default score. Scores can be customized by including or excluding attributes via a user interface, such as a trip quality dashboard (“TQD”). In addition, the travel scoring matrix can incorporate customized weighting schema, which attribute more weight to some attributes over others. Also, in some systems, end users, including travelers and agents, can customize the weight of each selected trip attribute, for example, using the trip quality dashboard.

### Overview of Use of the Travel Quality Scoring Process

In one embodiment of the present invention, the travel-scoring process includes the following steps:
1) A travel search is initiated via a travel distribution system. The search may be performed, for example, on-line or off-line through a travel agent.
2) A result set of travel options is returned, which provides individual travel solutions. Each travel option comprises a normalized set of elements that make up each respective travel solution.
3) The travel scoring process then evaluates each respective travel solution by examining the elements of the solution using the travel scoring matrix to generate an overall TQS for each unique itinerary.
4) A user can then invoke a TQD to customize a score to be generated by including/excluding one or more trip attributes and assigning weights to one or more attributes. The TQD can be used as well in an iterative fashion to observe the effect of different attribute and/or weighting choices on the resultant TQS.
   In one example implementation of the TQSS, the trip scoring process evaluates 45 or more trip attributes as they relate to qualitative aspects of the travel product. Other embodiments allow for the evaluation of different items and/or a different number of items. Below is a list of travel products with a sample subset of the trip attributes associated with the respective product being evaluated against an example TSM (a detailed explanation of these samples is provided below). In the following examples, the phrase <noun> “itinerary” refers to a travel-product (e.g., a travel plan or travel solution) that involves the <noun>. Thus, an airline itinerary may refer to a possible route and transport to fly from a source to a destination. A hotel itinerary may refer to a possible reservation at a hotel. Similarly, a cruise itinerary may refer to a possible booking of a cruise package or cruise vessel.

Airline itineraries trip attributes may include one or more of: (1) number of stops; (2) travel duration; (3) aircraft legroom; and (4) aircraft average age. Hotel itineraries trip attributes may include one or more of: (1) square footage of room; (2) year hotel built/renovated; (3) special event notification; and (4) on-site restaurant. Cruise itineraries trip attributes may include one or more of: (1) square footage of cabin; (2) year ship built/last renovated; (3) meal quality; and (4) number on-site restaurants.

### Assembling and Pricing Itineraries

Regardless of whether a user is shopping in an online environment or offline environment, such as being physically inside of a travel agency, the data that is incorporated to generate a list of travel solutions, by in large, originate from similar upstream processes. This data may be made available to third party systems, such as InsideTrip™, by existing processes that gather and aggregate such data from source data companies such as airlines, hotel businesses, etc. These aggregation processes, often provided by firms referred to as global distribution systems (“GDS”), typically merge three types of information: (1) the confirmed existence of a valid, physical travel product, such as an airline schedule, cruise ship schedule, or hotel reservation; (2) access to a list of prices of travel products subject to fare/pricing rules, such as a $400 fare on American Airlines between Boston and Los Angeles, subject to travel only allowed on Tuesdays, during the month of January; and (3) product availability/inventory insight, such as the $400 price on American Airlines is unavailable between Boston and Los Angeles on January 12^{th}.

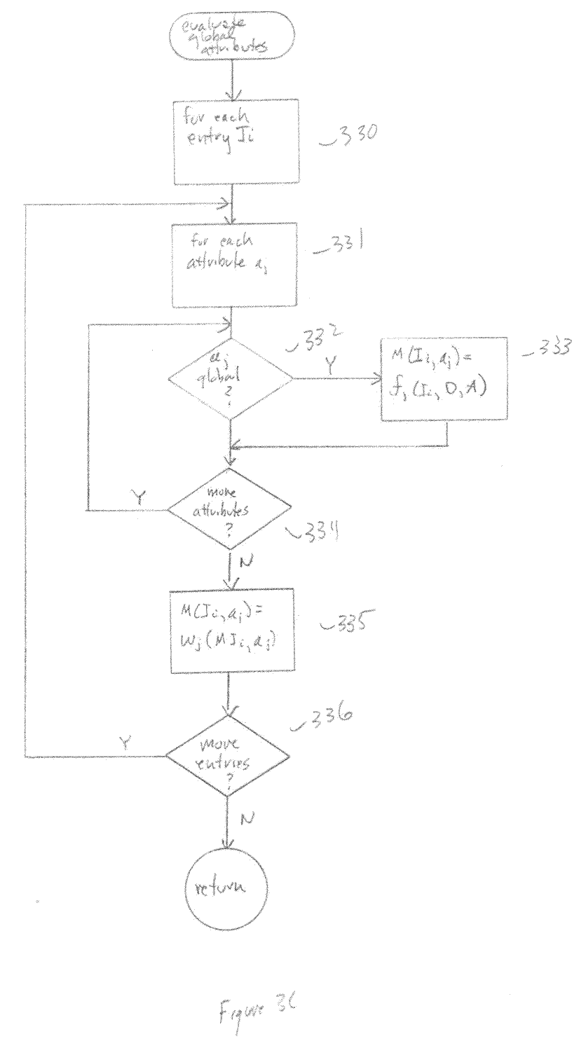

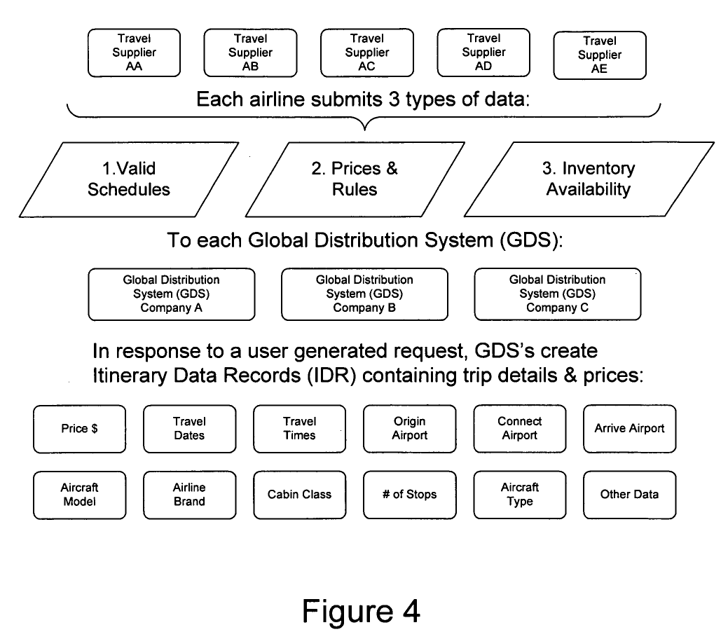

The above data aggregation processes are typically performed by technology firms, such as global distribution systems, whose primary function is to enable the distribution and sale of travel-related products. As a response to a user initiated query, these global distribution systems produce a standardized itinerary data record (“IDR”) containing normalized data elements for a particular travel product including, for example, price, brand, itinerary, and other relevant information pertinent to that travel selection. FIG. 4 shows how an itinerary data record is created in the distribution and sale of airline tickets according to various embodiments of the present invention.

Although the techniques of the travel scoring process and the travel quality scoring system are generally applicable to any type of travel-related product, the phrases “travel,” “trip,” “travel itinerary,” “travel reservation,” or “travel schedule” are used generally to imply any type of travel-related option that one can purchase, including but not limited to airline tickets, hotel reservations, cruise packages, vessel tickets, etc. Also, although many of the examples described herein relate to airlines and airline itineraries, it will be understood that similar techniques, matrixes, and scoring processes are equally applicable to other types of travel-related products, such as hotels, vacation packages, cruise packages, etc. and to other types of transportation, including, for example, cars, trains, boats, and other modes of transport.

Also, although certain terms are used primarily in this document, other terms could be used interchangeably to yield equivalent embodiments and examples. For example, it is well-known that equivalent terms in the travel field and in other similar fields could be substituted for such terms as “trip,” “itinerary,” “plan,” “schedule,” etc. Also, the term “attribute” can be used interchangeably with “aspect,” “characteristic,” etc. In addition, terms may have alternate spellings which may or may not be explicitly mentioned, and all such variations of terms are intended to be included.

### The Travel Scoring Matrix (“TSM”) and Travel Scoring Process (“TSP”)

In current systems, data from the IDR is typically presented to a user for his/her own interpretation and evaluation. By contrast, the travel scoring process examines elements contained in the IDR and scores these elements, as they pertain to one or more trip attributes, on a quality basis. In most cases, this involves utilizing supplemental data sources as part of the evaluation mechanism. One or more elements of an IDR may be considered, potentially in conjunction with the supplemental data, to for, each trip attribute that is evaluated for quality. For example, a trip attribute such as “Aircraft Age” may be garnered from aircraft model and airline brand elements of an IDR, in conjunction with external data such as the average aircraft age for that fleet for that airline. As a result, some elements are scored individually as well as in conjunction with other elements found within the IDR. Each trip attribute is scored, and then the scores are eventually rolled up to create one or more overall trip quality scores.

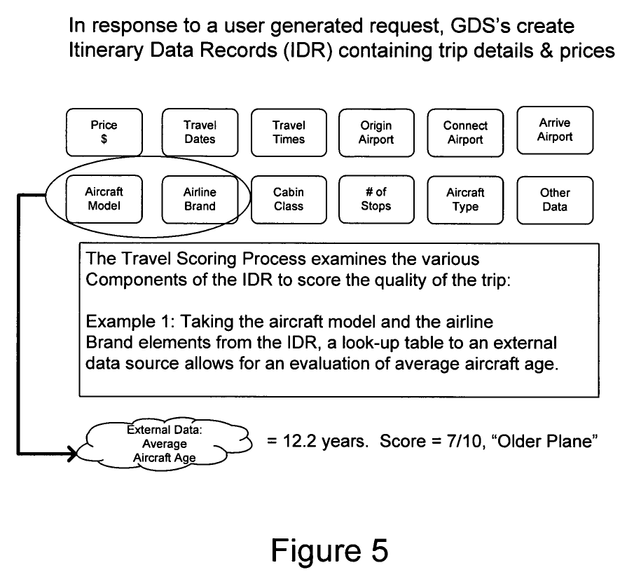

FIG. 5 demonstrates one example of the travel scoring matrix interaction with the itinerary data record in the evaluation of airline itineraries according to various embodiments of the present invention. FIG. 5 shows how aircraft age is evaluated and scored using elements from an IDR, aircraft model and airline brand, as well as externally provided data. Although FIG. 5 shows the travel scoring process evaluating only one trip quality attribute, average aircraft age, the process may, in another embodiment of the present invention, evaluate up to 45 or more trip attributes of an itinerary to produce an overall TQS. While the above examples from FIGS. 4 and 5 illustrate the dynamics of how airline itineraries are assembled and evaluated by the travel scoring process, a similar process can be applied across multiple travel product lines, including hotel, cruise, car, vacation packages, rail, and cruises, using appropriate TSMs. Because most travel-related products are distributed in similar fashion, via global travel distribution systems, the TQSS scales across travel-related product lines.

### Example Travel Scoring Matrix Trip Attributes for Airline Itinerary Evaluation

As noted previously, up to 45 or more trip attributes can be evaluated for each unique airline itinerary. Specifically, a trip attribute is an individual element of an itinerary that relates to trip quality and represents an aspect of a trip that can have material impact on the enjoyment or lack of enjoyment of a travel experience, many of the trip attributes mapping to one or more elements of an IDR. Thus, the importance of trip attributes may be subjective, as each person's enjoyment may be more highly influenced by some trip attributes more than others. An exemplary TQSS evaluates a set of default trip attributes with default weightings associated with them.

Table 1, provided below, details TQM contents for a airline travel product, including 12 different trip attributes currently used in a weighted scoring schema, listed first in Table 1, and additional elements that can be added at any time. In addition, in other embodiments of a TQSS, additional and/or different attributes and/or data mappings may be considered when computing evaluation scores.

TABLE 1
Trip Attributes Applicable to the Distribution/Sale of Airline Tickets

| Name of Attribute | | IDR Data-Key(s) | | External Data and/or Manipulation | |
|---|---|---|---|---|---|
| 1) | # of Stops - | # of Stops | | | |
| | intermediate stops | | | | |
| 2) | Travel Duration - | a. | Depart times of | i. | Calculation of elapsed in-flight |
| | total travel time of | | all flights | | time |
| | itinerary | b. | Arrive times of | ii. | Time zone file |
| | | | all flights | | |
| 3) | Flight On-Time | a. | Airline | i. | Flight on-time performance data |
| | Performance - | b. | Flight # | | |
| | historical flight on- | c. | Depart City | | |
| | time performance | d. | Arrive City | | |
| 4) | Security Wait Time - | a. | Airline | i. | Airline to airport terminal location |
| | historical queuing | b. | Departing | | mapping |
| | times through airport | | Airports | ii. | Airport terminal to unique security |
| | security | | | | checkpoint mapping |
| | | | | iii. | Airline to unique security |
| | | | | | checkpoint mapping |
| | | | | iv. | Security wait times data |
| 5) | Connection/Layover | a. | Depart times of | i. | Calculation of elapsed in-flight |
| | Time - amount of | | all flights | | time |
| | time waiting between | b. | Arrive times of | ii. | Time zone file |
| | connecting flights | | all flights | | |
| 6) | Routing Quality - | a. | Depart cities | i. | Airport coordinates |
| | degree the routing is | b. | Connect cities | ii. | GPS Point-to-point mileage |
| | out-of-the-way | c. | Arrival cities | | calculation |
| 7) | Lost Baggage Rank - | a. | Airline | i. | Department of Transportation lost |
| | historical ranking | | | | baggage ranking file |
| | of lost bags | | | | |
| 8) | Airport Gate | a. | Airlines | i. | Airline to airport terminal location |
| | Location - Ease of | b. | Depart Cities | | mapping |
| | Getting to/from | c. | Connect Cities | ii. | Intra-Airport Modes of |
| | Gates | d. | Arrival Cities | | Transportation |
| 9) | Aircraft Legroom - | a. | Operating | i. | Airline-Aircraft legroom data |
| | amount of space | | Airline | ii. | Codeshare flight number |
| | between seats, or | b. | Marketing | | translation to operating airline |
| | “seat pitch” | | Airline | | equipment |
| | | c. | Aircraft | | |
| | | | Equipment | | |
| 10) | Aircraft Age - | a. | Operating | i. | File detailing average aircraft fleet |
| | average age of an | | Airline | | age by airline and sub-fleet |
| | airline sub-fleet of | b. | Marketing | | |
| | scheduled aircraft | | Airline | | |
| | | c. | Aircraft | | |
| | | | Equipment | | |
| 11) | Aircraft Type - jet | a. | Aircraft model | i. | File classifying the aircraft model |
| | or prop aircraft | | | | as prop, regional jet, large jet, or |
| | | | | | wide-body jet |
| 12) | Typical Aircraft | a. | Airline | i. | File with historical passenger |
| | Passenger Loads - | b. | Depart City | | loads by airline and month |
| | historical % of seats | c. | Arrival City | | |
| | filled on a route | d. | Date | | |
| 13) | In-Flight Food - | a. | Airline | i. | File detailing in-flight food |
| | airline policies & | b. | Depart City | | policies (i.e. free, buy-on-board, or |
| | food quality | c. | Arrival City | | none) |
| | | | | ii. | Calculation of mileage |
| | | | | iii. | Calculation of time in-flight |
| 14) | In-Flight | a. | Operating | i. | File detailing the entertainment |
| | Entertainment - | | Airline | | policies by airline and aircraft |
| | airline policies and | b. | Aircraft | | model operated by that airline |
| | options | | Equipment | | |
| 15) | In-Flight Power - | a. | Depart cities | i. | File detailing the availability of in- |
| | extent to which | b. | Connect cities | | seat power by airline and aircraft |
| | power is provided | c. | Arrival cities | | model operated by that airline |
| | in-flight | | | | |
| 16) | Aircraft Overhead | a. | Operating | i. | File detailing the cubic dimensions |
| | Luggage Stowage | | Airline | | of each airline's sub-fleet of |
| | Space - amount of | b. | Aircraft | | aircraft |
| | overhead space | | Equipment | | |
| 17) | Airline Frequent | a. | Airline | i. | Schedule of frequent flyer |
| | Flyer Program | | | | alliances and the reciprocal |
| | Alliances | | | | mileage earning/burning |
| | | | | | opportunities |
| 18) | Airline | a. | Airline | i. | File detailing airlines current and |
| | Bankruptcy Status | | | | historical bankruptcy status |
| | & History | | | | |
| 19) | Airline # of Planes | a. | Airline | i. | File detailing the fleet size of each |
| | in Fleet | | | | airline |
| 20) | Airline # of Daily | a. | Airline | i. | File detailing the number of daily |
| | Non-stop Flights in | | | | non-stop flights in a given market |
| | a Given Market | | | | for each airline |
| 21) | Airline # of | a. | Airline | i. | File detailing the number of |
| | Alliance Partners | | | | alliance partners for each airline |
| 22) | Airline Airfare | a. | Airline | | |
| | Rules - flexibility | b. | Airfare rules | | |
| | of airline airfare | | | | |
| | rules | | | | |
| 23) | Airline Airfare | a. | Airline | i. | File detailing airfare change |
| | Change Policies - | | | | policies by airline |
| | flexibility of airline | | | | |
| | change rules | | | | |
| 24) | Airline Airfare | a. | Airline | i. | File detailing airfare refund |
| | Refund Policies - | | | | policies by airline |
| | flexibility of airline | | | | |
| | refund policies | | | | |
| 25) | Airline Customer | a. | Airline | i. | File detailing customer service |
| | Service Ranking - | | | | complaints by airline |
| | historical airline | | | | |
| | customer complaints | | | | |
| 26) | Airline Airport | a. | Airline | i. | File detailing overall on-time |
| | On-time | | | | performance by airline |
| | Performance - | | | | |
| | historical airport | | | | |
| | data | | | | |
| 27) | Airline Passenger | a. | Airline | i. | File detailing airline passenger |
| | Bumping Rate - | | | | bumping (denied boarding) rate |
| | historical rate airline | | | | |
| | denies boarding of | | | | |
| | ticketed passengers | | | | |
| 28) | Multi-carrier | a. | Airline | | |
| | Itinerary Quality - | b. | Connection | | |
| | ease of flying | | City | | |
| | multiple airlines in a | | | | |
| | single itinerary | | | | |
| 29) | Multi-airport | a. | Airline | | |
| | Itinerary Quality - | b. | Departing | | |
| | ease of using | | Airport | | |
| | different | c. | Connecting | | |
| | depart/arrive | | Airport | | |
| | airports in a single | d. | Arrival Airport | | |
| | itinerary | | | | |
| 30) | Airline Hub Delays - | a. | Airline | i. | File detailing airline hub cities |
| | historical flight | b. | Departing | | delays |
| | delays of an airline | | Airport | | |
| | at one its respective | c. | Connecting | | |
| | hub cities | | Airport | | |
| | | d. | Arrival Airport | | |
| 31) | Airfare Historical | a. | Airfare | i. | File detailing historical airfare |
| | Price Comparison - | | | | prices by airline and by origin and |
| | historical view of | | | | destination city pair |
| | average prices paid | | | | |
| 32) | User-Generated: | a. | Airline | i. | Database of user-generated |
| | Aircraft Type | b. | Aircraft | | feedback regarding aircraft type |
| | Comments | | Equipment | | |
| 33) | User-Generated: | a. | Airline | i. | Database of user-generated |
| | Airline Comments | | | | feedback regarding airline |
| | | | | | opinions |
| 34) | User-Generated: | a. | Airlines | i. | Database of user-generated |
| | Airport & Gate | b. | Depart Cities | | feedback regarding airport & gate |
| | Location | c. | Connect Cities | | locations |
| | Comments | d. | Arrival Cities | | |
| 35) | User-Generated: | a. | Depart Cities | i. | Database of user-generated |
| | Route Comments | b. | Connect Cities | | feedback regarding aircraft routing |
| | | c. | Arrival Cities | | |
| 36) | User-Generated: | a. | Airline | i. | Database of user-generated |
| | Frequent Flyer | | | | feedback regarding airline frequent |
| | Comments | | | | flyer programs |
| 37) | User-Generated: | a. | Airline | i. | Database of user-generated |
| | Food Policies & | b. | Aircraft | | feedback regarding airline food |
| | Quality Comments | | Equipment | | policies and quality |
| 38) | User-Generated: | a. | Airline | i. | Database of user-generated |
| | In-Flight | b. | Aircraft | | feedback regarding airline in-flight |
| | Entertainment | | Equipment | | entertainment |
| | Comments | | | | |
| 39) | User-Generated: | a. | Airline | i. | Database of user-generated |
| | Security Wait | b. | Departing | | feedback regarding security wait |
| | Time Comments | | Airports | | times |
| 40) | User-Generated: | a. | Depart times of | i. | Database of user-generated |
| | Connection/ | | all flights | | feedback regarding |
| | Layover Time | b. | Arrive times of | | connection/layover time |
| | | | all flights | | |
| 41) | User-Generated: | a. | Airline | i. | Database of user-generated |
| | Lost Baggage | | | | feedback regarding lost baggage |
| | Comments | | | | |
| 42) | User-Generated: | a. | Operating | i. | Database of user-generated |
| | Aircraft Legroom | | Airline | | feedback regarding aircraft |
| | Comments | b. | Marketing | | legroom |
| | | | Airline | | |
| | | c. | Aircraft | | |
| | | | Equipment | | |
| 43) | User-Generated: | a. | Operating | i. | Database of user-generated |
| | Aircraft Average | | Airline | | feedback regarding aircraft |
| | Age Comments | b. | Marketing | | average age |
| | | | Airline | | |
| | | c. | Aircraft | | |
| | | | Equipment | | |
| 44) | User-Generated: | a. | Airline | i. | Database of user-generated |
| | Typical Aircraft | b. | Depart City | | feedback regarding typical aircraft |
| | Passenger Loads | c. | Arrival City | | passenger loads |
| | Comments | d. | Date | | |
| 45) | User-Generated: | a. | Airline | i. | Database of user-generated |
| | Flight Solution | b. | Departing | | feedback regarding most |
| | Popularity Rank | | Airport | | commonly clicked on flight results |
| | | c. | Arrival Airport | | |
| 46) | User-Generated: | a. | Other Data | i. | Database of user-generated |
| | Other Comments | | | | feedback regarding other issues |

### Travel Scoring Process: Methodologies for Scoring Using a TQM

Within the travel scoring process, at least two weighted methodologies can be used to generate the TQS from the data and the TQM: (1) a build-up approach; and (2) a penalty or decrement approach. Using the build-up approach, each attribute contributes some amount of points based upon its importance weighting and the value of the attribute in the data being examined. Using the penalty approach, points are taken away based upon the importance weighting and value of the attribute in the data being examined.

Steps employed in an exemplary Build-Up Approach include:
a. Each trip attribute is assigned a weighted value of perceived “importance.”
b. Each trip attribute is assigned a maximum possible achievable point value (considered the mathematical denominator for that attribute).
c. Two other tiered point values are established based upon trip quality.
d. Thus, each attribute can be assigned one of three point values (considered the mathematical numerators):
   i. Best Quality: full point value
   ii. Moderate Quality: partial point value
   iii. Low Quality: little or no assigned point value
e. The attributes may be grouped together in summary categories such as Speed, Comfort, and Ease.
f. The numerators and denominators are each summed up to create a composite score representing the number of earned points divided by the maximum achievable points. Thus, the quotient represents the percentage of achieved points and is normalized to a value out of 100%.
g. The process accordingly may generate:
   i. a score for each trip attribute;
   ii. a score for each of the summary categories;
   iii. an overall score for all trip attributes.
h. In addition, summary trip quality scores may be created on a:
   i. directional basis, e.g., an outbound TQS and a return TQS for each attribute, each summary category, and the all of the trip attributes combined; and
   ii. an overall TQS for the complete trip (e.g., multiple directions).
      Note that, in different embodiments, a different number of values, or tiers, may be established for one or more trip attributes in the TQM. In addition, directional scores may be computed on a per “travel leg” basis, for example, where connecting airline flights are relevant.

TABLE 2
TQS Option 1: TQM “Build-Up” Methodology

| Name of Attribute | | Outcome/Result | | Point Value |
|---|---|---|---|---|
| 1) | # of Stops | a. | Non-stop | 600 |
| | | b. | 1-stop | 400 |
| | | c. | 2+ stops | 300 |
| 2) | Travel Duration | a. | Fastest 15% of trips | 100 |
| | | b. | Fastest 15-50% of trips | 50 |
| | | c. | Slowest 50% of trips | 0 |
| 3) | Flight On-Time | a. | Greater than 80% on-time | 60 |
| | Performance | b. | Between 50% and 80% on-time | 30 |
| | | c. | Less than 50% on-time | 0 |
| 4) | Security Wait | a. | Less than 5 minute wait time | 60 |
| | Times | b. | Between 5 and 12 minutes wait | 30 |
| | | | time | |
| | | c. | Greater than 12 minutes wait time | 0 |
| 5) | Connection/Layover | a. | Between 45 and 90 minutes | 60 |
| | Time (Domestic) | b. | Less than 45 and between 90 and | 30 |
| | | | 180 minutes | |
| | | c. | Greater than 180 minutes | 0 |
| 5) | Connection/Layover | a. | Between 90 and 150 minutes | 60 |
| | Time | b. | Less than 90 minutes and | 30 |
| | (International) | | between 150 minutes and 180 | |
| | | | minutes | |
| | | c. | Greater than 180 minutes | 0 |
| 6) | Routing Quality - | a. | Route traveled miles of 110% or | 60 |
| | degree the routing | | less of non-stop | |
| | is out-of-the-way | b. | Route traveled miles of | 30 |
| | | | between 110% and 125% of non- | |
| | | | stop | |
| | | c. | Route traveled miles of greater | 0 |
| | | | than 125% of non-stop | |
| 7) | Lost Baggage Rank | a. | Airline ranking within top 3 of | 30 |
| | | | 20 | |
| | | b. | Airline ranking between 4 and 6 | 20 |
| | | c. | Airline ranking greater than 6 | 0 |
| 8) | Airport Gate | a. | Departure Gate: Walk or Ride | 30 |
| | Location & Ease of | b. | Departure Gate: Ride | 0 |
| | Getting to/from | c. | Connecting Gate: Walk or Ride | 30 |
| | Gates | d. | Connecting Gate: Ride | 0 |
| | | e. | Arrival Gate: Walk or Ride | 30 |
| | | f. | Arrival Gate: Ride | 0 |
| 9) | Aircraft Legroom | a. | Seat pitch 32.5″ or greater | 60 |
| | | b. | Seat pitch between 31″ and 32.5″ | 30 |
| | | c. | Seat pitch less than 31″ | 0 |
| 10) | Average Aircraft | a. | Avg. age less than 5 years | 30 |
| | Age by Airline | b. | Avg. age between 5 and 12 years | 20 |
| | Sub-fleet | c. | Avg. age greater than 12 years | 0 |
| 11) | Aircraft Type | a. | Large Jet | 30 |
| | | b. | Regional Jet | 20 |
| | | c. | Non-Jet | 0 |
| 12) | Typical Aircraft | a. | Less than 60% full | 60 |
| | Passenger Loads | b. | Between 60 and 80% full | 30 |
| | | c. | Greater than 80% full | 0 |

Steps employed in an exemplary penalty approach include:
a. Each trip attribute is assigned a weighted value of perceived “importance.”
b. All individual travel itineraries start out at a perfect score of ‘100’.
c. For each attribute, the best or optimal trip quality is assigned a value of ‘0’
d. Two other tiered point values (penalties) are established based upon trip quality.
e. Thus, each attribute can be assigned one of three point values:
   i. Best Quality: no point penalty or ‘0’
   ii. Moderate Quality: partial point penalty
   iii. Low Quality: full point penalty
f. The attributes may be grouped together in summary categories such as Speed, Comfort, and Ease.
i. All trip attributes are scored and each point value successively decremented (or not) against the overall score from highest possible achievable score of ‘100’ to arrive at a trip quality score.
j. The process accordingly may generate:
   i. a score for each trip attribute;
   ii. a score for each of the summary categories;
   iii. an overall score for all trip attributes.
g. In addition, summary trip quality scores may be created on a:
   i. directional basis, e.g., an outbound TQS and a return TQS for each attribute, each summary category, and the all of the trip attributes combined; and
   ii. an overall TQS for the complete trip (e.g., multiple directions).
      Note that, in different embodiments, a different number of values, tiers, may be established for one or more trip attributes in the TQM. In addition, directional scores may be computed on a per “travel leg” basis, for example, where connecting airline flights are relevant.

TABLE 3
TQS Option 2: TQM “Decrement” Methodology

| Name of Attribute | | Outcome/Result | | Point Value |
|---|---|---|---|---|
| 1) | # of Stops | a. | Non-stop | 0 |
| | | b. | 1-stop | 10 |
| | | c. | 2+ stops | 20 |
| 2) | Travel Duration | a. | Fastest 15% of trips | 0 |
| | | b. | Fastest 15-50% of trips | 1 |
| | | c. | Slowest 50% of trips | 2 |
| 3) | Flight On-Time | a. | Greater than 80% on-time | 0 |
| | Performance | b. | Between 50% and 80% on-time | 1 |
| | | c. | Less than 50% on-time | 2 |
| 4) | Security Wait Times | a. | Less than 5 minute wait time | 0 |
| | | b. | Between 5 and 12 minutes wait | 1 |
| | | | time | |
| | | c. | Greater than 12 minutes wait | 2 |
| | | | time | |
| 5) | Connection/Layover | a. | Between 45 and 90 minutes | 0 |
| | Time (Domestic) | b. | Less than 45 and between 90 and | 1 |
| | | | 180 minutes | |
| | | c. | Greater than 180 minutes | 2 |
| 5) | Connection/Layover | a. | Between 90 and 150 minutes | 0 |
| | Time | b. | Less than 90 minutes and | 1 |
| | (International) | | between 150 minutes and 180 | |
| | | | minutes | |
| | | c. | Greater than 180 minutes | 2 |
| 6) | Routing Quality - | a. | Route traveled miles of 110% or | 0 |
| | degree the routing | | less of non-stop | |
| | is out-of-the-way | b. | Route traveled miles of | 1 |
| | | | between 110% and 125% of non- | |
| | | | stop | |
| | | c. | Route traveled miles of greater | 2 |
| | | | than 125% of non-stop | |
| 7) | Lost Baggage Rank | a. | Airline ranking within top 3 of | 0 |
| | | | 20 | |
| | | b. | Airline ranking between 4 and 6 | 1 |
| | | c. | Airline ranking greater than 6 | 2 |
| 8) | Airport Gate | a. | Departure Gate: Walk or Ride | 0 |
| | Location & Ease of | b. | Departure Gate: Ride | 1 |
| | Getting to/from | c. | Connecting Gate: Walk or Ride | 0 |
| | Gates | d. | Connecting Gate: Ride | 1 |
| | | e. | Arrival Gate: Walk or Ride | 0 |
| | | f. | Arrival Gate: Ride | 1 |
| 9) | Aircraft Legroom | a. | Seat pitch 32.5″ or greater | 0 |
| | | b. | Seat pitch between 31″ and | 1 |
| | | | 32.5″ | |
| | | c. | Seat pitch less than 31″ | 2 |
| 10) | Average Aircraft | a. | Avg. age less than 5 years | 0 |
| | Age by Airline Sub- | b. | Avg. age between 5 and 12 | 1 |
| | fleet | | years | |
| | | c. | Avg. age greater than 12 years | 2 |
| 11) | Aircraft Type | a. | Large Jet | 0 |
| | | b. | Regional Jet | 1 |
| | | c. | Non-Jet | 2 |
| 12) | Typical Aircraft | a. | Less than 60% full | 0 |
| | Passenger Loads | b. | Between 60 and 80% full | 1 |
| | | c. | Greater than 80% full | 2 |

### Example and Comparison Using Build-Up and Decrement Scoring Methodologies

A typical travel distribution system can return up to 500 or more unique itineraries in response to a query. An example presented below illustrates how the TQSS develops travel quality scores for a unique itinerary on both a directional basis and a round-trip basis. In addition, this single itinerary is evaluated using both the build-up and decrement TSM methodologies.
Example Itinerary: Seattle (SEA) to Orlando (MCO) round-trip on American Airlines (AA), leaving on Dec. 8, 2007 and returning on Dec. 14, 2007. The specific flights being evaluated include AA departing flights #1212 (SEA to DFW) connecting to AA flight #1734 (DFWMCO) and AA returning flights #897 (MCO to DFW) connecting to AA flight #1585 (DFWSEA).
   Table 4, provided below, presents a summary of the trip quality scores generated on both a directional and overall basis. The build-up approach generates an overall TQS of 62%, with departure and return directions generating respective scores of 60% and 64%. In turn, the decrement approach generates an overall TQS of 78%, with departure and return directions generating respective scores of 77% and 79%. Note that each TQS may be expressed as a percentage, a numeric value, or by some other indicator such as a graphic, symbol, icon, color, shape, texture, etc.

TABLE 4
TQS Comparison

| Trip Quality Score | BUILD-UP | DECREMENT |
|---|---|---|
| Departure Direction | 60% | 77% |
| Return Direction | 64% | 79% |
| Overall Trip Quality | 62% | 78% |

Tables 5 and 6 below illustrate the process for evaluating the example data to derive detailed scoring results for directional itineraries as well as the different scoring results that are generated using the build-up and decrement methodologies.

### Departure Direction Scoring:

Seattle (SEA) to Orlando (MCO) on American Airlines (AA) with a connection in Dallas (DFW). The specific itinerary involves AA flight #1212 (SEA to DFW) connecting to AA flight #1734 (DFW to MCO) departing on Dec. 8, 2007.

TABLE 5
TQS Results for Departure-Direction Itinerary

| Departure Direction Scoring: | | | | BUILD-UP | | DECREMENT | |
|---|---|---|---|---|---|---|---|
| Seattle (SEA) to Orlando (MCO) | | | | Score | Best Possible | Score | Best Possible |
| Attribute | | IDR Value(s) | External Data | Value | Score Value | Value | Score Value |
| 1) | # of Stops | 1 stop flight | | 400 | 600 | −10 | 0 |
| 2) | Travel Duration | 7 hrs, 15 min | Comparison to fastest | 50 | 100 | −1 | 0 |
| | | | flights in results set | | | | |
| 3) | Flight On-Time | AA Flight #1212 | On-time: 72% | 42 | 60 | −1 | 0 |
| | Performance¹ | AA Flight #1734 | On-time: 85% | | | | |
| 4) | Security Wait Times | AA, SEA airport | 15 minute avg | 0 | 60 | −2 | 0 |
| 5) | Connection/Layover Time | 1 hour, 25 min | | 60 | 60 | 0 | 0 |
| | (Domestic) | | | | | | |
| 6) | Routing Quality - degree | Route: SEA-DFW-MCO | Total Routed miles: | 60 | 60 | 0 | 0 |
| | the routing is out-of-the-way | | 104% of nonstop | | | | |
| 7) | Lost Baggage Rank | AA | Ranking: 12^{th} out of 20 | 0 | 30 | −2 | 0 |
| 8) | Airport Gate Location & East | Depart: SEA | SEA: Walk to Gate | 30 | 90 | −2 | 0 |
| | of Getting to/from Gates | Connect: DFW | DFW: Train to Gate | | | | |
| | | Arrive: MCO | MCO: Train to Term. | | | | |
| 9) | Aircraft Legroom | AA Flight #1212: B757 | AA B757: 32″ seat pitch | 30 | 60 | −1 | 0 |
| | | AA Flight #1734: B757 | | | | | |
| 10) | Average Aircraft | AA Flight #1212: B757 | AA B757: 12.25 yrs | 0 | 30 | −2 | 0 |
| | Age by Airline Sub-fleet | AA Flight #1734: B757 | avg age | | | | |
| 11) | Aircraft Type | AA Flight #1212: B757 | B757: Jet | 60 | 60 | 0 | 0 |
| | | AA Flight #1734: B757 | | | | | |
| 12) | Typical Aircraft | AA Flight #1212: B757 | AA Flight #1212: 85% Full | 12 | 30 | −2 | 0 |
| | Passenger Loads¹ | AA Flight #1734: B757 | AA Flight #1734: 92% Full | | | | |

| | | | | |
|---|---|---|---|---|
| Total Points | 744 | 1240 | 77 | 100 |
| Directional Trip Quality Score (TQS): | 60.0% | 100.0% | 77.0% | 100.0% |

¹Score weighted by transported miles

### Return Direction Scoring:

Orlando (MCO) to Seattle (SEA) on American Airlines (AA) with a connection in Dallas (DFW). The specific itinerary involves AA flight #897 (MCO to DFW) connecting to AA flight #1585 (DFW to SEA) departing on Dec. 14, 2007.

TABLE 6
TQS Results for Return-Direction Itinerary

| Return Direction Scoring: | | | | BUILD-UP | | DECREMENT | |
|---|---|---|---|---|---|---|---|
| Orlando (MCO) to Seattle (SEA) | | | | Score | Best Possible | Score | Best Possible |
| Attribute | | IDR Value(s) | External Data | Value | Score Value | Value | Score Value |
| 1) | # of Stops | 1 stop flight | | 400 | 600 | −10 | 0 |
| 2) | Travel Duration | 8 hrs, 20 min | Comparison to fastest | 50 | 100 | −1 | 0 |
| | | | flights in results set | | | | |
| 3) | Flight On-Time | AA Flight #897 | On-time: 76% | 30 | 60 | −1 | 0 |
| | Performance¹ | AA Flight #1585 | On-time: 68% | | | | |
| 4) | Security Wait Times | AA, MCO airport | 1 minute avg | 60 | 60 | 0 | 0 |
| 5) | Connection/Layover Time | 1 hour, 10 min | | 60 | 60 | 0 | 0 |
| | (Domestic) | | | | | | |
| 6) | Routing Quality—degree | Route: MCO-DFW-SEA | Total Routed miles: | 60 | 60 | 0 | 0 |
| | the routing is out-of-the-way | | 104% of nonstop | | | | |
| 7) | Lost Baggage Rank | AA | Ranking: 12^{th} out of 20 | 0 | 30 | −2 | 0 |
| 8) | Airport Gate Location | Depart: MCO | MCO: Train to Gate | 30 | 90 | −2 | 0 |
| | & East of Getting | Connect: DFW | DFW: Train to Gate | | | | |
| | to/from Gates | Arrive: SEA | SEA: Walk to Term. | | | | |
| 9) | Aircraft Legroom | AA Flight #897: B757 | 32″ seat pitch | 30 | 60 | −1 | 0 |
| | | AA Flight #1585: B757 | | | | | |
| 10) | Average Aircraft | AA Flight #897: B757 | AA B757: 12.25 yrs | 0 | 30 | −2 | 0 |
| | Age by Airline Sub-fleet | AA Flight #1585: B757 | avg age | | | | |
| 11) | Aircraft Type | AA Flight #897: B757 | AA B757: Jet | 60 | 60 | 0 | 0 |
| | | AA Flight #1585: B757 | | | | | |
| 12) | Typical Aircraft | AA Flight #897: | AA Flight #897: 88% Full | 12 | 30 | −2 | 0 |
| | Passenger Loads¹ | AA Flight #1585: | AA Flight #1585: 85% Full | | | | |

| | | | | |
|---|---|---|---|---|
| Total Points | 792 | 1240 | 79 | 100 |
| Directional Trip Quality Score (TQS): | 63.9% | 100.0% | 79.0% | 100.0% |

### Manipulation of the Travel Scoring Matrix (“TSM”) and Trip Quality Score (“TQS”)

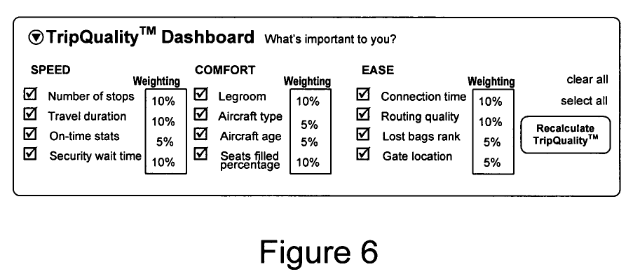

Although any suitable user interface may be using to control and customize the TSM attributes, rules, weights, etc, an example TQSS provides a trip quality dashboard (“TQD”) to support the customization of flight itinerary quality metrics based upon user interaction with the trip attributes. A default TSM, such as generated for the first 12 attributes in Table 1, employs 12 trip attributes that relate to quality; however, by utilizing the TQD, the user can isolate only those elements deemed important for his/her given trip. By selecting/deselecting one or more attributes, the user can calculate a customized score, which takes into account only those attributes tailored for that user. In addition to selecting/deselecting attributes, the user can also create a customized weighting for one or more of the attributes. FIG. 6 illustrates an example interface of an example trip quality dashboard according to various embodiments of the present invention.

When the user selects various trip attributes and weights, the TQSS automatically makes sure that no less and no more than 100% total weights are allocated. In system environments that combine some customization with default values, it is conceivable the TQSS may allocate less than 100%, augmenting the final score with its own trip attributes for the remainder, or, alternatively, may allocate a full 100%, which is, in turn, weighted proportionally when other default attributes are also incorporated. Other permutations are possible.

### Normalized Itinerary Data Record Database Schema

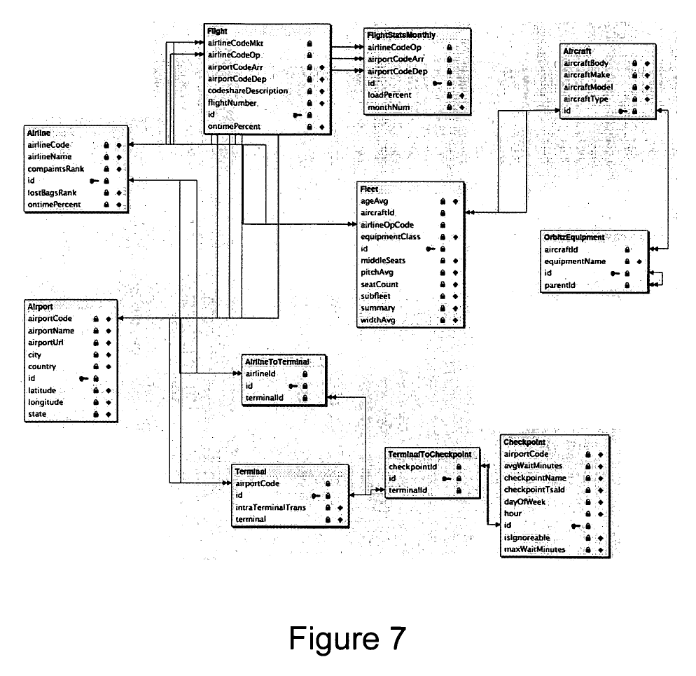

The ability to evaluate and score the data found within an IDR is predicated on a flexible relational database schema. The TQSS data platform is normalized such that it can ingest IDRs from virtually any data source that contains the relevant data-keys as inputs. FIG. 7 illustrates a relational database structure for use with the TSMs and travel scoring processes according to on embodiment of the present invention. It will be understood that other equivalent data structures for storing relational data, and other arrangements of data, can be similarly supported. In addition, policies for incomplete and/or missing data can also be employed.

### INSIDETRIP™ as an Example Airline Travel Product Solution

The technology of the InsideTrip™ TQSS can be made available to users and third party systems in multiple forms. The TQSS has been architected to create a flexible data sharing platform with other travel-related applications. The TQSS can share data, TQMs, and methods, including methods accessed through application programming interfaces, for manipulating them, TQM schema, access to its evaluation and scoring engine for scoring externally provided trip attribute data, etc. In addition, a portion of or the entire TQSS can be embedded in other applications for providing travel-related solutions, which include quality measurements.

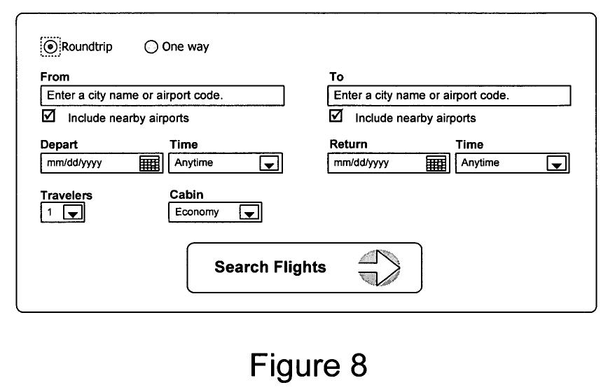

Embodiments of the present invention may be deployed in consumer-facing travel shopping web sites, or client applications. User steps may include, for example: (1) a search for airfare; (2) viewing of prices and respective TQSs; (3) tailoring TQS using the TQD; and (4) other aspects of the trip quality presentations. FIGS. 8-11 illustrate user steps in evaluating travel options according to one embodiment of the present invention.

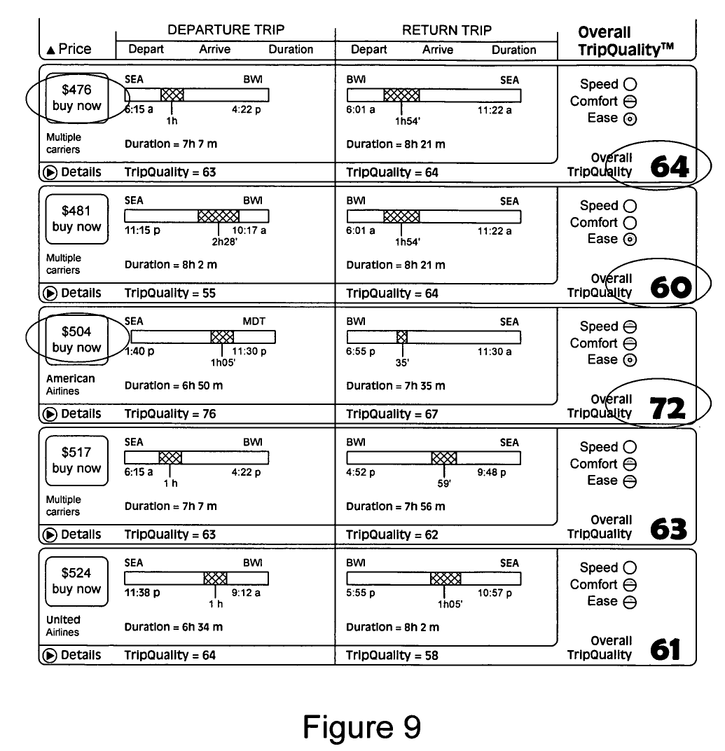

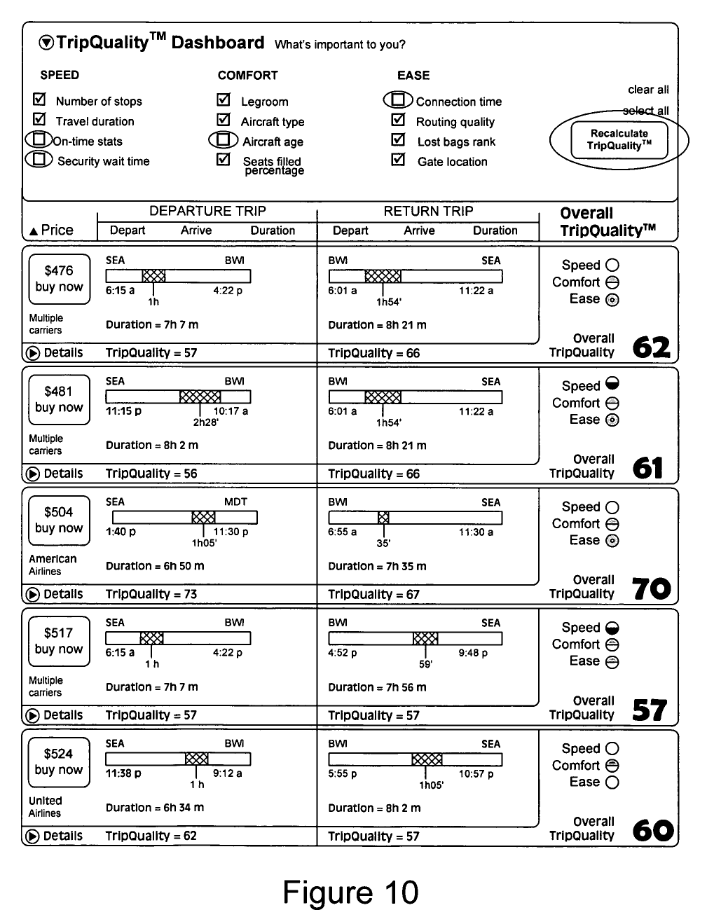

In some embodiments, a user may be able to purchase travel-related products, such as an airline ticket, at the time the search results are presented, or at other opportunities. For example, a user can select one of the “Buy Now” control buttons for the Seattle to Baltimore itinerary to purchase a ticket for one of the travel options shown in FIGS. 9-10. In this manner, the user can decide on, and immediately purchase, an option makes sense, taking into account the quality of the respective itinerary at the same time as price. Note that an interface for customizing weightings for one or more trip attributes can be incorporated such as the interface shown in FIG. 6.

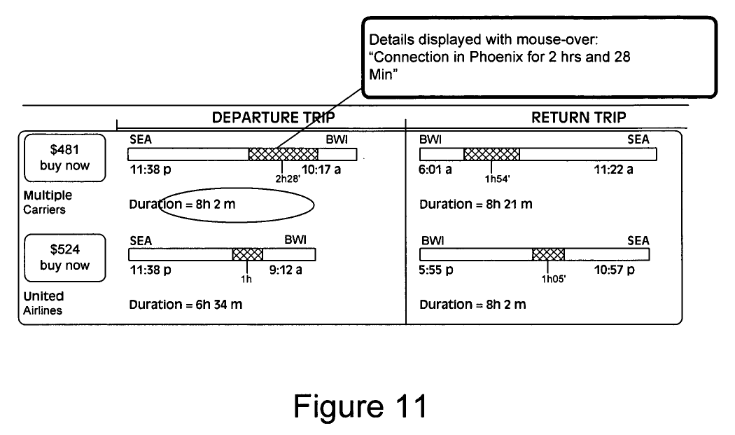

In addition to the trip quality scores supplementing the search results on the right hand side of FIGS. 9 and 10, graphical indicators of the summary categories of trip attributes can also be presented and used to display additional quality-related information about the underlying travel itinerary and various travel solutions. For example, FIG. 11 illustrates an itinerary having an interactive visual display, or flight bar, for each leg of the itinerary for each individual travel solution. In some embodiments, four aspects of the visual representation promote easy comparison and evaluation of itineraries, including:
1) Visual exposure of all events, including flights and layovers, contained with a given itinerary. Layovers are marked with holes or gaps in the flight bars. Also, mouse-overs or other types of interactive input selection allow for further flight information to be disclosed. For example, when a user hovers an input device over a connection graphic, verbiage is displayed, such as “connection in Phoenix-Sky Harbor Airport for 2 hrs and 28 min,” providing further insight into the connection. In addition, the display may be augmented by audio or video.
2) The scheduled elapsed time of the itinerary is depicted using a bar chart to illustrate overall elapsed travel time. The starting point (time zero) of the chart represents the initial departure of a given flight and all itineraries start at this same visual reference point. The scaling process of the flight schedules to create a visual snapshot can utilize at least two methodologies:
   a. In an application with finite visual space, the length of each bar may be scaled relative to the longest directional itinerary found within the flight results set generated by a global distribution system.
   b. Alternatively, the length of a bar may be scaled to a fixed time horizon. For example, one inch could equal 1 hour of flight time and thus the length of the bar relates to the number of travel hours of the itinerary being evaluated.
3) Vertical display of “same direction,” or departure-and-return-segment, itineraries.
4) Horizontal display of round-trip, or departure-and-return-segment, itineraries.

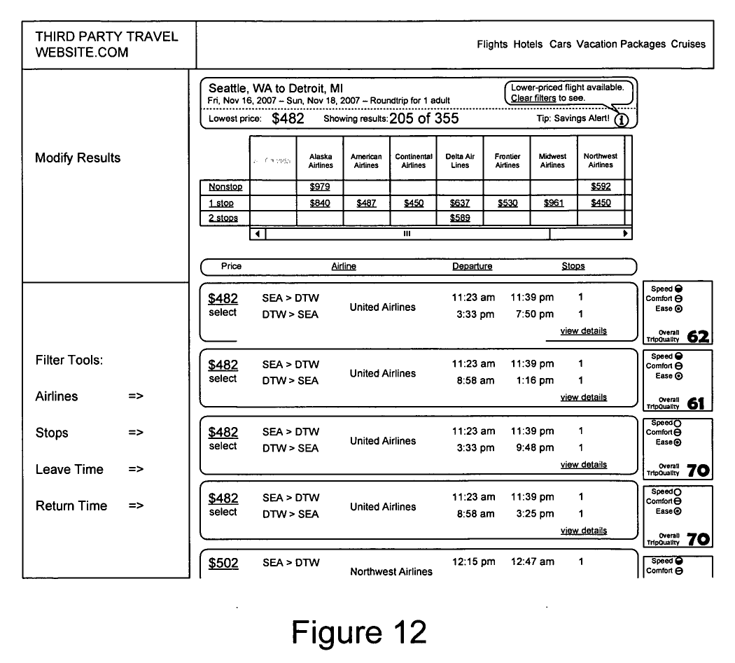

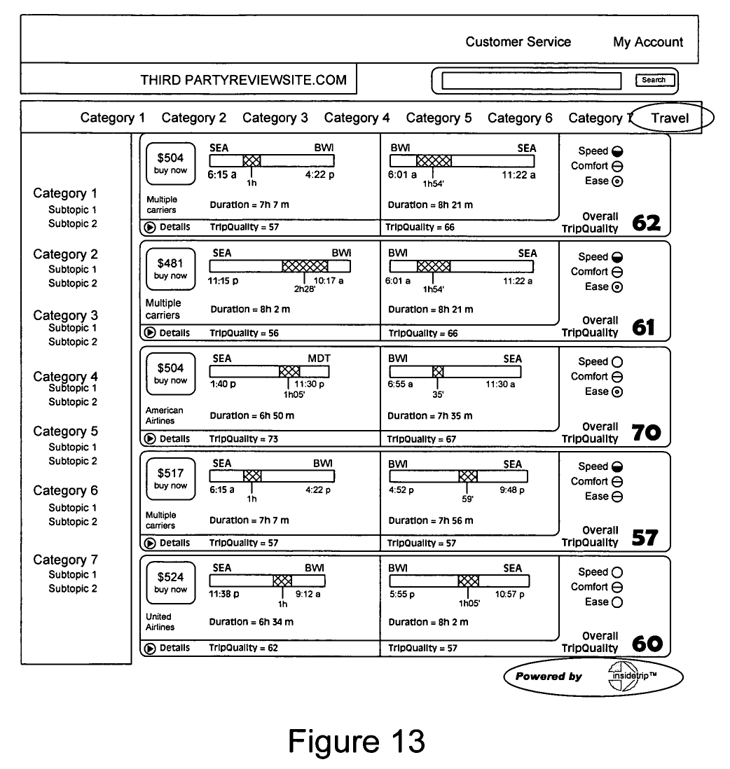

Embodiments of the present invention may be deployed in other ways. FIG. 12 illustrates licensing of the travel scoring matrix and travel scoring process to third parties for use in their applications according to on embodiment of the present invention. FIG. 13 illustrates a private/white label of consumer-facing travel shopping web site by embedding a portion or entire TQSS into a third party application to provide travel functionality according to on embodiment of the present invention. Other deployments and possible combinations are also possible.

### Addition Details Concerning the Present Invention

Embodiments described herein provide enhanced computer- and network-based methods, techniques, and systems for the near-real time assessment of the quality of one or more travel-related products. Example embodiments provide a Travel Quality Scoring System (“TQSS”), which enables users to evaluate, score, and ultimately assess the relative quality of one travel-related product option over another, in order to make reasoned decisions. For example, using an example TQSS, attributes that contribute to a measure of quality of an airline itinerary can be evaluated and scored in near-real time. The user can then purchase the travel products associated with the itinerary that most reflects a quality fit that the user seeks. For example, a travel itinerary that uses airline flight have no stops (no connecting flights), arriving generally on-time, and having newer planes with extra leg room may receive a higher quality score than one that uses a flight having a single stop, arriving only 80% on-time.

In some embodiments, an example TQSS employs evaluation and scoring techniques to derive an overall score for a travel-related product, referred to as a Trip Quality Score (“TQS”), which indicates a measure of quality for that trip. In some instances, a TQS may be derived for one or more portions of a travel itinerary as well as combined into an overall score. For example, separate TQS measures may be determined for each direction of air travel, or each hotel reserved for a trip. A Trip Quality Score is calculated based upon rules and data stored in a Trip Quality Matrix (“TQM”), which specifies a weighted combination of variety of trip attributes that are in turn derived from data that can be ingested from a travel distribution system, such as one that generates itinerary data records, typically in combination with external data. The matrix defines how data ingested from a particular itinerary data record will be combined and evaluated against a set of defined, and potentially weighted, attributes. In some embodiments, certain trip attributes are weighted more heavily in their importance to an overall quality assessment. In other embodiments, one or more of the attributes are weighted the same. In addition, in some embodiments, the TQSS allows users to customize, for example using a graphical interactive user interface, which attributes will be examined in determining the TQS, and the relative weight of each such selected attribute.

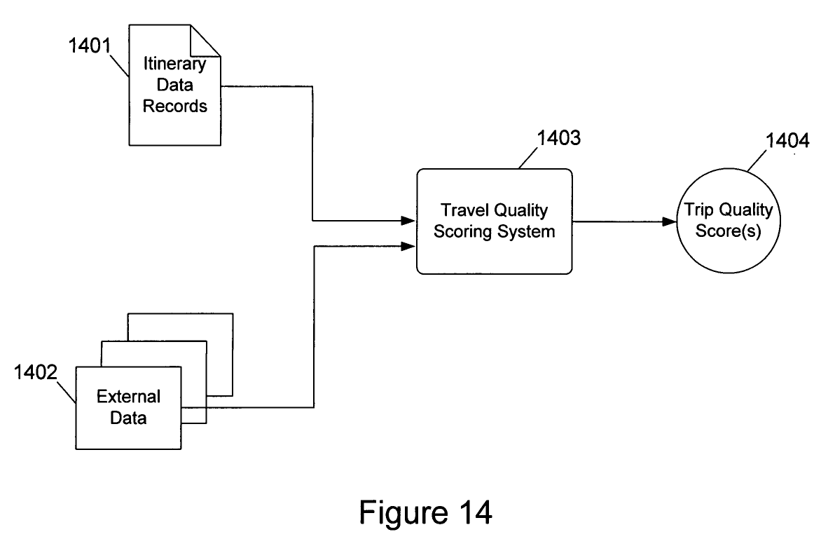

FIG. 14 is an example block diagram of use of a Travel Quality Scoring System to provide quality measurements of travel-related products. In FIG. 14, itinerary data records 1401 are received from one or more sources of travel-related data, for example hotel room information, flight information, vessel specifications, etc. and forwarded, along with external data 1402 to the TQSS 1403. Internal data may also be incorporated. The TQSS 1403 processed the received and determined data, evaluating it against the rules and mappings specified by a travel quality matrix to generate one or more Trip Quality Score(s) 1404.

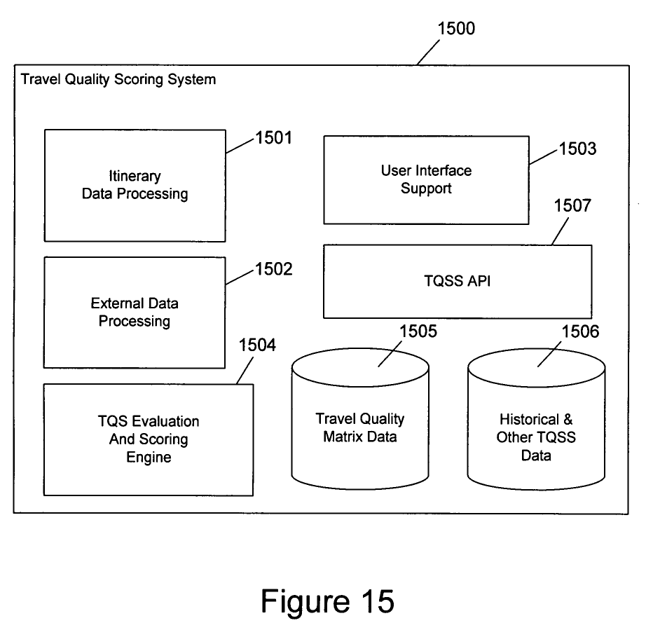

In one example embodiment, the Travel Quality Scoring System comprises one or more functional components/modules that work together to provide near real-time quality assessment of one or more travel-related products. FIG. 15 is an example block diagram of example components of a Travel Quality Scoring System. These components may be implemented in software or hardware or a combination of both. For example, a typical TQSS 1500 may comprise an itinerary data record processing component 1501, an external, or other, data processing component 1502, customized/dashboard 1503, an evaluation and scoring engine 1504, one of more data repositories 1505 and 1506, and an application programming interface (“API”) 1507 for accessing particular components and/or data produced by the system. The itinerary data record processing component 1501 processes data, typically received from a travel distribution system, to and groups the data according to the trip attributes defined by a travel quality matrix. The external, or other, data processing component 1502 receives and processes data, such as from other databases, such as information pertaining to mechanical records, fleet data, etc. The customized/dashboard 1503 presents tools for allowing a user to tailor the attributes that contribute to a TQS. The evaluation and scoring engine 1504 examines the received and otherwise determined data from internal data repositories, for example, trip quality historical data stored in repository 1506, in accordance with one of the travel quality matrixes, stored, for example data repository 1505.

Example embodiments described herein provide applications, tools, data structures and other support to implement a Travel Quality Scoring System to be used for accessing quality of travel-related products. In the following description, numerous specific details are set forth, such as data formats, steps, and sequences, etc., in order to provide a thorough understanding of the described techniques. The embodiments described also can be practiced without some of the specific details described herein, or with other specific details, such as changes with respect to the ordering of the sequences, different sequences, etc. Thus, the scope of the techniques and/or functions described are not limited by the particular order, selection, or decomposition of steps described with reference to any particular Figure.

In an example embodiment related to air travel, the TQM specifies a default of set of trip attributes, which related to comfort associated with air travel, and the TQSS produces Travel Quality Scores that rate the quality of an air travel itinerary. A detailed description of an example TQSS, called InsideTrip™ follows.

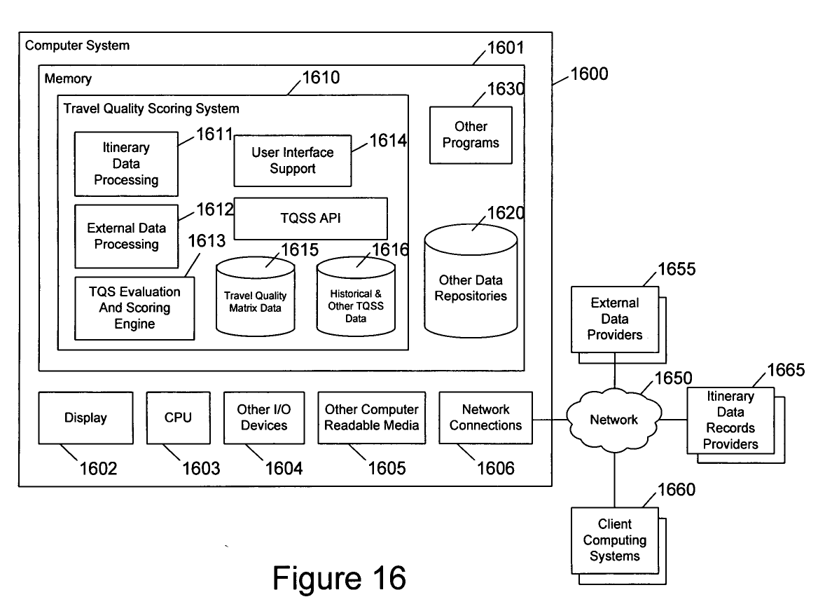

FIG. 16 is an example block diagram of an example computing system that may be used to practice embodiments of a Travel Quality Scoring System described herein. Note that a general purpose or a special purpose computing system may be used to implement a “TQSS.” Further, the TQSS may be implemented in software, hardware, firmware, or in some combination to achieve the capabilities described herein.

The computing system 1600 may comprise one or more sever and/or client computing systems and may span distributed locations. In addition, each block shown may represent one or more such blocks as appropriate to a specific embodiment or may be combined with other blocks. Moreover, the various blocks of the Travel Quality Scoring System 1610 may physically reside on one or more machines, which use standard (e.g., TCP/IP) or proprietary interprocess communication mechanisms to communicate with each other.

In the embodiment shown, computer system 1600 comprises a computer memory (“memory”) 1601, a display 1602, one or more Central Processing Units (“CPU”) 1603, Input/Output devices 1604 (e.g., keyboard, mouse, CRT or LCD display, etc.), other computer-readable media 1605, and network connections 1606. The TQSS 1610 is shown residing in memory 1601. In other embodiments, some portion of the contents, some of, or all of the components of the TQSS 1610 may be stored on or transmitted over the other computer-readable media 1605. The components of the TQSS 1610 preferably execute on one or more CPUs 1603 and manage the generation and use of travel quality scores, as described herein. Other code or programs 1630 and potentially other data repositories, such as data repository 1606, also reside in the memory 1610, and preferably execute on one or more CPUs 1603. Of note, one or more of the components in FIG. 16 may not be present in any specific implementation. For example, some embodiments embedded in other software may not provide means for user input or display.

In a typical embodiment, the TQSS 1610 includes one or more itinerary data processors 1611, one or more external data processors 1612, and a TQS Evaluation and Scoring Engine 1613, user interface support 1614, and a TQSS API 217. In at least some embodiments, the data processing portions 1611 and 1612 are provided external to the TQSS and are available, potentially, over one or more networks 1650. Other and/or different modules may be implemented. In addition, the TQSS may interact via a network 1650 with one or more itinerary data providers 1665 that provide itinerary data to process, one or more client computing systems or other application programs 1660 (e.g., that use results computed by the TQSS 1610), and/or one or more third-party external data records providers 1655, such as purveyors of information used in the historical data in data repository 1616. Also, of note, the historical data in data repository 1616 may be provided external to the TQSS as well, for example in a travel knowledge base accessible over one or more networks 1650.

In an example embodiment, components/modules of the TQSS 1610 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by a TQSS implementation.

In addition, programming interfaces to the data stored as part of the TQSS 1610 (e.g., in the data repositories 1615 and 1616) can be available by standard means such as through C, C++, C#, and Java APIs; libraries for accessing files, databases, or other data repositories; through scripting languages such as XML; or through Web servers, FTP servers, or other types of servers providing access to stored data. The components 1615 and 1616 may be implemented as one or more database systems, file systems, or any other method known in the art for storing such information, or any combination of the above, including implementation using distributed computing techniques. In addition, the TSM rules may be implemented as stored procedures, or methods attached to trip attribute “objects,” although other techniques are equally effective.

Also the example TQSS 1610 may be implemented in a distributed environment comprising multiple, even heterogeneous, computer systems and networks. For example, in one embodiment, the itinerary data processing 1611, the evaluation and scoring engine 1613, and the TQM data repository 1615 are all located in physically different computer systems. In another embodiment, various modules of the TQSS 1610 are hosted each on a separate server machine and may be remotely located from the tables which are stored in the data repositories 1615 and 1616. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.). Other variations are possible. Also, other functionality could be provided by each component/module, or existing functionality could be distributed amongst the components/modules in different ways, yet still achieve the functions of a TQSS.

Furthermore, in some embodiments, some or all of the components of the TQSS may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the system components and/or data structures may also be stored (e.g. as software instructions or structured data) on a computer-readable medium, such as a hard disk, a memory, a network, or a portable media article to be read by an appropriate drive or via an appropriate connection. Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of the invention. For example, the methods and systems for performing travel-related product quality assessment discussed herein are applicable to other architectures other than a client-server or web-based architecture. Also, the methods and systems discussed herein are applicable to differing protocols, communication media, including optical, wireless, cable, etc., and devices, including wireless handsets, electronic organizers, personal digital assistants, portable email machines, game machines, pagers, navigation devices such as GPS receivers, etc.

### Implementation Details of One Embodiment of the Present Invention

Appendix A includes a database schema for a database that is used by an evaluation service to evaluate travel-related products according to on embodiment of the present invention. Appendix B includes a pseudocode implementation of an air-travel-itineraries evaluation implementation of the present invention.

Although the present invention has been described in terms of particular embodiments, it is not intended that the invention be limited to these embodiments. Modifications will be apparent to those skilled in the art. For example, any of a number of different programming languages and database-management systems can be used to implement embodiments of the present invention. Various embodiments of the present invention may be implemented by varying familiar programming parameters, including modular organization, control structures, data structures, variables, and other such parameters. As discussed above, product-evaluation according to the present invention may be carried out in client-side applications, by evaluation services, by vendors, and by other parties, services, and computational facilities. While airplane itineraries represent an exemplary travel-related product, many other travel-related products can be evaluated by embodiments of the present invention.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An evaluation system comprising:
a vendor which, upon receiving a request, supplies information about a specific travel-related product or service as a list of entries, each entry describing a travel-related product or service; and
an evaluation-service which
receives the list of entries,
computes values for each of a number of attributes associated with the travel-related product or service described by each entry in the list of entries, computing the attribute values for each entry using information contained in the entry, information contained in a database, and values of attributes computed for one or more entries in the list of entries,
computes one or more evaluation scores for each entry in the list of entries using the attribute values computed for the attributes associated with the entry, and
transmits the evaluation scores for display to the user, printing to the user, or storage in a computer-readable medium for subsequent access by a user.

2. The evaluation system of claim 1 further including:
a client-side application that
runs on a user's electronic device,
receives the evaluation scores from the evaluation service, and
communicates the one or more evaluation scores for the entries in the list of entries to the user, by displaying the evaluation scores on a display device, printing the evaluation scores, storing the evaluation scores on a computer-readable medium for subsequent access by the user, or transmitting the evaluation scores to an electronic device for display, printing, or storage.

3. The evaluation system of claim 2 wherein the client-side application requests information about a specific travel-related product or service by transmitting the request to the vendor.

4. The evaluation system of claim 2 wherein the client-side application requests information about a specific travel-related product or service by transmitting the request to the evaluation service, which forwards the request to the vendor.

5. The evaluation system of claim 1 wherein the evaluation service runs on a remote computer system distinct from the vendor and from the user's device.

6. The evaluation system of claim 1 wherein the evaluation service runs on a computer system associated with the vendor.

7. The evaluation system of claim 1 wherein the evaluation service runs on the user's electronic device.

8. The evaluation system of claim 1 wherein the travel-related product is an air-travel itinerary.

9. The evaluation system of claim 1 wherein the attributes associated with the air-travel itinerary include two or more of:
airport-related attributes;
aircraft-related attributes;
flight-related attributes;
airline-related comments; and
consumer evaluations.

10. The evaluation system of claim 9 wherein the airport-related attributes include one or more of:
historical security-check time;
historical baggage-delivery reliability;
airport on-time performance;
gate location; and
customer-service ranking.

11. The evaluation system of claim 9 wherein the aircraft-related attributes include one or more of:
aircraft age;
in-flight power availability;
aircraft type; and
overhead stowage space.

12. The evaluation system of claim 9 wherein the airline-related attributes include one or more of:
historical on-time performance;
historical baggage-delivery reliability;
historical aircraft passenger load;
in-flight-food quality;
in-flight-entertainment quality;
frequent-flyer-program quality;
frequent-flyer-program alliances;
airline financial health;
airline size in airplanes;
number of daily non-stop flights provided by airline;
number of airline partners of airline;
airfare flexibility;
travel-change flexibility;
refund policies;
customer-service ranking;
airline bumping rate;
multi-carrier itinerary quality;
multi-airport itinerary quality;
airline hub delays; and
fare.

13. The evaluation system of claim 9 wherein the flight-related attributes include one or more of:
number of stops;
historical on-time performance;
travel duration;
historical security-check time;
connection time;
routing quality;
gate location;
historical aircraft passenger load; and
in-flight-food quality.

14. The evaluation system of claim 9 wherein the consumer evaluations include two or more of:
aircraft-type comments;
airline comments;
gate-location comments;
airport-location comments;
route comments;
frequent-flyer-program comments;
food-quality comments;
in-flight entertainment comments;
security-check-time comments;
connection-time comments;
lost-baggage comments;
legroom comments;
aircraft-age comments;
passenger-loads comments; and
flight-popularity comments.
